(19) United States
(12) Patent Application Publication
(10) Pub. No.: US 2026/0245512 A1
(43) Pub. Date: Aug. 20, 2026

(54) PIXEL DRIVING CIRCUIT AND DRIVING METHOD THEREFOR AND DISPLAY PANEL

(71) Applicant: BOE Technology Group Co., Ltd., Beijing (CN)

(72) Inventor: Li WANG, Beijing (CN)

(73) Assignee: BOE Technology Group Co., Ltd., Beijing (CN)

(21) Appl. No.: 18/992,619

(22) PCT Filed: Apr. 20, 2023
(86) PCT No.: PCT/CN2023/089604

§ 371 Date: Jan. 9, 2025

(51) Int. Cl. G09G 3/3233

(52) U.S. Cl. CPC G09G 3/3233; G09G 2300/0819; G09G 2300/0842; G09G 2310/0254; G09G 2310/08; G09G 2320/0247; G09G 2330/021

(57) ABSTRACT

A pixel driving circuit includes: a first reset module, connected to a first node, a first initialization signal terminal and a reset signal terminal, and configured to write a signal of the first initialization signal terminal into the first node in response to a signal of the reset signal terminal; a driving module, connected to the first node, a second node and a third node, and providing a driving current to the third node based on voltages of the first node and the second node; a coupling module, connected to the first node and a preset node, and configured to couple a voltage change of the first node to the preset node and couple a voltage change of the preset node to the first node; and a first switch module, connected to a constant voltage terminal, the preset node and a switch signal terminal.

### CROSS-REFERENCE TO RELATED APPLICATION

The present application is a U.S. National Stage of International Application No. PCT/CN2023/089604, filed on Apr. 20, 2023, the contents of which are incorporated herein by reference in its entirety for all purposes.

### TECHNICAL FIELD

The present disclosure relates to the field of display technologies, and in particular, to a pixel driving circuit and a driving method thereof, and a display panel.

### BACKGROUND

In display technologies, low frequency helps reduce system power consumption and improve display endurance.

It should be noted that the information disclosed in the Background section above is only for enhancing the understanding of the background of the present disclosure, and thus may include information that does not constitute prior art known to those of ordinary skill in the art.

### SUMMARY

According to an aspect of the present disclosure, there is provided a pixel driving circuit, including: a first reset module, connected to a first node, a first initialization signal terminal and a reset signal terminal, wherein the first reset module is configured to write a first initialization signal to the first node in response to a signal of the reset signal terminal; a driving module, connected to the first node, a second node and a third node, wherein the driving module is configured to provide a driving current to the third node based on voltages of the first node and the second node; a coupling module, connected to the first node and a preset node, wherein the coupling module is configured to couple a voltage change of the first node to the preset node and couple a voltage change of the preset node to the first node; a first switch module, connected to a constant voltage terminal, the preset node and a switch signal terminal, wherein the first switch module is configured to turn on in response to a signal of the switch signal terminal to stabilize the preset node using the constant voltage terminal or to turn off in response to the signal of the switch signal terminal to control the preset node to float.

It should be noted that the above general description and the following detailed description are merely exemplary and explanatory and should not be construed as limiting of the disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure. Apparently, the drawings in the following description are only some embodiments of the present disclosure. For those of ordinary skilled in the art, other drawings may be obtained based on these drawings without paying any creative effort.

FIG. 1 is a schematic structural diagram of a pixel driving circuit according to an embodiment of the present disclosure;

FIG. 2 is a schematic structural diagram of a pixel driving circuit according to another embodiment of the present disclosure;

FIG. 3 is a timing diagram of respective nodes in FIG. 2;

FIG. 4 is an equivalent circuit diagram of the pixel driving circuit of FIG. 2 in a reset stage of a refresh frame;

FIG. 5 is an equivalent circuit diagram of the pixel driving circuit of FIG. 2 in a data writing stage of a refresh frame;

FIG. 6 is an equivalent circuit diagram of the pixel driving circuit of FIG. 2 in a pre-light-emitting bias stage of a refresh frame;

FIG. 7 is an equivalent circuit diagram of the pixel driving circuit of FIG. 2 in a light-emitting stage of a refresh frame;

FIG. 8 is an equivalent circuit diagram of the pixel driving circuit of FIG. 2 in a reset stage of a hold frame;

FIG. 9 is a schematic structural diagram of a pixel driving circuit according to another embodiment of the present disclosure;

FIG. 10 is a timing diagram of respective nodes in FIG. 9;

FIG. 11 is an equivalent circuit diagram of the pixel driving circuit of FIG. 9 in a reset stage of a refresh frame;

FIG. 12 is an equivalent circuit diagram of the pixel driving circuit of FIG. 9 in a data writing stage of a refresh frame;

FIG. 13 is an equivalent circuit diagram of the pixel driving circuit of FIG. 9 in a pre-light-emitting bias stage of a refresh frame;

FIG. 14 is an equivalent circuit diagram of the pixel driving circuit of FIG. 9 in a light-emitting stage;

FIG. 15 is an equivalent circuit diagram of the pixel driving circuit of FIG. 9 in a reset stage of a hold frame;

FIG. 16 is a schematic structural diagram of a pixel driving circuit according to another embodiment of the present disclosure;

FIG. 17 is a timing diagram of respective nodes in FIG. 16;

FIG. 18 is an equivalent circuit diagram of the pixel driving circuit of FIG. 16 in a first reset stage of a refresh frame;

FIG. 19 is an equivalent circuit diagram of the pixel driving circuit of FIG. 16 in a second reset stage of a refresh frame;

FIG. 20 is an equivalent circuit diagram of the pixel driving circuit of FIG. 16 in a first reset stage of a hold frame;

FIG. 21 is an equivalent circuit diagram of the pixel driving circuit of FIG. 16 in a second reset stage of a hold frame;

FIG. 22 is a structural schematic diagram of a pixel driving circuit according to another embodiment of the present disclosure;

FIG. 23 is a timing diagram of respective nodes of the pixel driving circuit shown in FIG. 22;

FIG. 24 is an equivalent circuit diagram of the pixel driving circuit of FIG. 22 in a reset stage of a refresh frame;

FIG. 25 is an equivalent circuit diagram of the pixel driving circuit of FIG. 22 in a data writing stage of a refresh frame;

FIG. 26 is an equivalent circuit diagram of the pixel driving circuit of FIG. 22 in a light-emitting stage of a refresh frame;

FIG. 27 is an equivalent circuit diagram of the pixel driving circuit of FIG. 22 in a reset stage of a hold frame;

FIG. 28 is an equivalent circuit diagram of the pixel driving circuit of FIG. 22 in a light-emitting stage of a hold frame;

FIG. 29 is a schematic structural diagram of a pixel driving circuit according to another embodiment of the present disclosure;

FIG. 30 is a timing diagram of respective nodes of the pixel driving circuit shown in FIG. 29;

FIG. 31 is an equivalent circuit diagram of the pixel driving circuit of FIG. 29 in a reset stage of a refresh frame;

FIG. 32 is an equivalent circuit diagram of the pixel driving circuit of FIG. 29 in a data writing stage of a refresh frame;

FIG. 33 is an equivalent circuit diagram of the pixel driving circuit of FIG. 29 in a light-emitting stage of a refresh frame;

FIG. 34 is an equivalent circuit diagram of a pixel driving circuit of FIG. 29 in a reset stage of a hold frame;

FIG. 35 is an equivalent circuit diagram of the pixel driving circuit of FIG. 29 in a light-emitting stage of a hold frame;

FIG. 36 is a schematic structural diagram of a pixel driving circuit according to another embodiment of the present disclosure;

FIG. 37 is a timing diagram of respective nodes in FIG. 36;

FIG. 38 is an equivalent circuit diagram of the pixel driving circuit of FIG. 36 in a reset stage of a refresh frame;

FIG. 39 is an equivalent circuit diagram of the pixel driving circuit of FIG. 36 in a data writing stage of a refresh frame;

FIG. 40 is an equivalent circuit diagram of the pixel driving circuit of FIG. 36 in a pre-light-emitting bias stage of a refresh frame;

FIG. 41 is an equivalent circuit diagram of the pixel driving circuit of FIG. 36 in a light-emitting stage of a refresh frame;

FIG. 42 is an equivalent circuit diagram of the pixel driving circuit of FIG. 36 in a reset stage of a hold frame;

FIG. 43 is an equivalent circuit diagram of the pixel driving circuit of FIG. 36 in a pre-light-emitting bias stage of a hold frame;

FIG. 44 is an equivalent circuit diagram of the pixel driving circuit of FIG. 36 in a data writing stage of a hold frame.

### DETAILED DESCRIPTION

Example embodiments will now be described more fully with reference to the accompanying drawings. However, the example embodiments can be implemented in a variety of forms and should not be construed as being limited to examples set forth herein; rather, these embodiments are provided so that the present disclosure will be more complete and comprehensive so as to convey the idea of the example embodiments to those skilled in this art. The same reference numerals in the drawings denote the same or similar structures, and the repeated description thereof will be omitted. In addition, the drawings are merely schematic representations of the present disclosure and are not necessarily drawn to scale.

In the related arts, in a driving process of a long frame period, a hold frame does not reset a driving module 130, which causes operating states of the driving module 130 to be different in the hold frame and in a refresh frame, thereby causing the difference in the display brightness in the refresh frame and the hold frame, resulting in flickering.

The following is a unified description of various signals involved in the present disclosure.

A first initialization signal is the first initialization signal, a second initialization signal is the second initialization signal, a third initialization signal is a signal of a third initialization signal terminal Vinit3, and a data signal is a signal of a data signal terminal Vdata.

FIG. 1 is a schematic structural diagram of a pixel driving circuit according to an embodiment of the present disclosure. It should be understood that the pixel driving circuit may further include other circuit structures. The figure only shows a partial structure of the pixel driving circuit to exemplify a principle that the pixel driving circuit of the present disclosure can eliminate the difference in the operating state in the hold frame and the refresh frame. As shown in FIG. 1, the pixel driving circuit may include a first reset module 110, a driving module 130, a coupling module 200 and a first switch module 190. The first reset module 110 is connected to a first node N1, a first initialization signal terminal Vinit1 and a reset signal terminal Re, and the first reset module 110 is configured to write the first initialization signal to the first node N1 in response to a signal of the reset signal terminal Re. The driving module 130 is connected to the first node N1, a second node N2 and a third node N3, and the driving module 130 is configured to provide a driving current to the third node N3 under the action of a voltage difference between the first node N1 and the second node N2. The coupling module 200 is connected to the first node N1 and a preset node A, and the coupling module 200 is configured to couple a voltage change of the first node N1 to the preset node A and couple a voltage change of the preset node A to the first node N1. The first switch module 190 is connected to a constant voltage terminal VM, the preset node A and a switch signal terminal SW, and the first switch module 190 is configured to turn on in response to a signal of the switch signal terminal SW to stabilize the preset node A by using the constant voltage terminal VM or turn off in response to the signal of the switch signal terminal SW to control the preset node A to float.

In the pixel driving circuit provided in the present disclosure, the coupling module 200 is connected to the first node N1 and the preset node A, the first switch module 190 is connected to the preset node A and the constant power terminal. In the reset stage of the hold frame, the first switch module 190 can be controlled to be turned off to make the preset node A float, and the first reset module 110 can be controlled to write the first initialization signal to the first node N1, and the coupling module 200 couples the voltage change of the first node N1 to the floating preset node A. Accordingly, bias voltages of the driving module 130 between the first node N1 and the second node N2 in the reset stage of the refresh frame and the refresh stage of the hold frame are the same. In addition, due to the existence of the first switch module 190, the first switch module 190 can be controlled to be turned on after the reset stage of the hold frame to use the coupling module 200 to couple the voltage change of the preset node A to the first node N1. Accordingly, a potential of the first node N1 is the same as a potential before reset, thereby eliminating or reducing the problem of uneven brightness caused by the difference in the operating state of the driving module 130 in the refresh frame and the hold frame, and improving the flickering problem of the display panel under low-frequency driving.

The pixel driving circuit in the present disclosure can be used for low-frequency long-frame-period driving, which means that refreshing one frame of data is maintained for a duration of a plurality of frames. A driving method for a pixel driving circuit in the present disclosure can perform a reset once in each hold frame, so that a bias voltage of the driving module 130 in the hold frame is the same as a bias voltage of the driving module 130 in the refresh frame, and accordingly, the pixel driving circuit can provide the same magnitude of driving current in the hold frame and the refresh frame.

In a reset stage of the refresh frame, the reset signal terminal Re outputs an on-level to control the first reset module 110 to be turned on, so that the first initialization signal can be transmitted to the first node N1 to reset the first node N1. In this process, a voltage of the second node N2 can be stabilized to VH, so that a voltage difference ΔV_{A}=Vinit1−VH between the first node N1 and the second node N2 is a bias voltage of the driving module 130. In the present disclosure, the second node N2 can be connected to a stable voltage source VH or a stable voltage can be written to the second node N2 through another reset circuit, so that the second node N2 has a stable voltage in this stage. For a specific circuit, reference can be made to the introduction of subsequent embodiments, which will not be elaborated here.

In a driving process of the hold frame, the first node N1 is also reset once. Specifically, the first reset module 110 transmits the first initialization signal to the first node N1, and the first switch module 190 is also controlled to be turned off to make the preset node A float. Accordingly, the coupling module 200 can couple the voltage change ΔV_{N1}=Vinit1−V0 of the first node N1 to the preset node A, where V0 is a voltage of the first node N1 before coupling, so that a voltage of the preset node A becomes VA=VM+(Vinit1−V0), where VM is a voltage provided by the constant voltage terminal VM. Similarly, in this process, the second node N2 can be stabilized to VH, so that the voltage difference between the first node N1 and the second node N2 is also ΔV_{A}=Vinit1−VH, which is the bias voltage of the driving module 130. It can be seen that after the driving module is reset by the hold frame, the bias voltage of the driving module is the same as the bias voltage of the driving module in the refresh frame, thereby eliminating the problem of the difference in the display brightness caused by the different bias voltages of the driving module 130 between the refresh frame and the hold frame.

In addition, after the reset stage of the refresh frame ends, the first switch module 190 can be controlled to be turned on, so that the preset node A is stabilized to VM by the constant voltage terminal VM, and the voltage change of the preset node A is ΔV_{A}=VM−(VM+(Vinit1−V0))=V0−Vinit1. In addition, the first reset module 110 is controlled to be turned off to make the first node N1 float, and accordingly, the coupling module 200 can couple the voltage change ΔV_{A}=V0−Vinit1 of the preset node A to the first node N1, so that the voltage of the first node N1 is changed to VA=V0 again. Thus, after the reset stage of the hold frame, the first node N1 maintains the same voltage as before reset, that is, the voltage of the first node N1 will not be changed, and the pixel driving circuit can maintain the original state to emit light.

In the present disclosure, a level output by a certain signal terminal being an on-level can be understood as the level output by this signal terminal being able to conduct or turn on a circuit structure connected to the signal terminal or to pull up a node voltage connected to this signal terminal. Correspondingly, a level output by a certain signal terminal being a non-on level means that the level signal output by this signal terminal can turn off a circuit structure connected to this signal terminal or pull down a node voltage connected to this signal terminal.

A circuit structure and operating principle of the pixel driving circuit in the present disclosure are specifically introduced in combination with a specific circuit below.

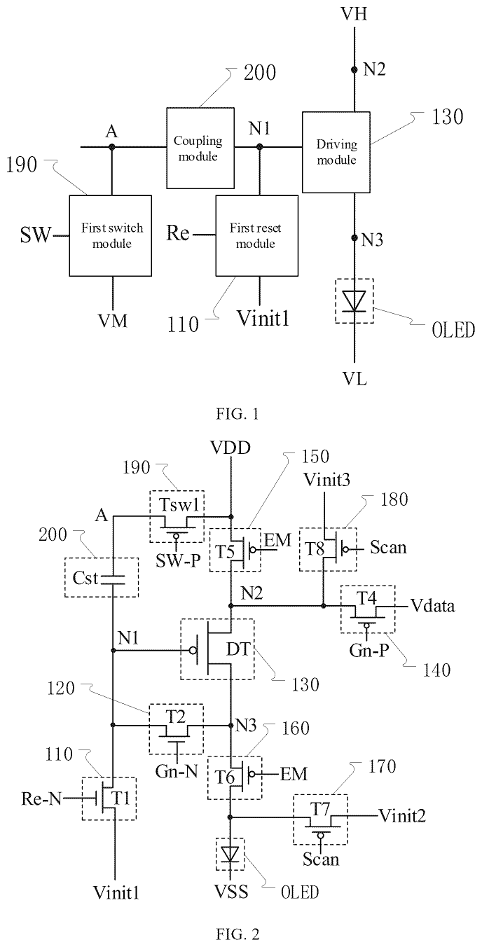

FIG. 2 is a schematic structural diagram of a pixel driving circuit according to another embodiment of the present disclosure. As shown in FIG. 2, in an embodiment, the constant voltage terminal VM is a first power terminal VDD, that is, the preset node A is connected to the first power terminal VDD through the first switch module 190. The switch signal terminal SW may include a first switch signal terminal SW-P, the reset signal terminal Re may include a first reset signal terminal Re-N, and a cathode of a light-emitting device OLED may be connected to a second power terminal VSS. The pixel driving circuit may further include a second reset module 180, a first transmission module 120, a data writing module 140, a first light-emitting control module 150, a second light-emitting control module 160 and a third reset module 170. The second reset module 180 is connected to the second node N2, a third initialization signal terminal Vinit3 and a scan signal terminal Scan, and the second reset module 180 may be configured to write the third initialization signal to the second node N2 in response to a signal of the scan signal terminal Scan. The first transmission module 120 is connected to the first node N1, the third node N3 and a first gate signal terminal Gn-N, and the first transmission module 120 may be configured to turn on or turn off a connection between the first node N1 and the third node N3 in response to a signal of the first gate signal terminal Gn-N. The data writing module 140 is connected to the second node N2, the data signal terminal Vdata and a second gate signal terminal Gn-P, and the data writing module 140 may be configured to transmit a data signal to the second node N2 in response to a signal of the second gate signal terminal Gn-P. The first light-emitting control module 150 is connected to the second node N2, the first power terminal VDD and an enable signal terminal EM, and the first light-emitting control module 150 may be configured to transmit a voltage signal of the first power terminal VDD to the second node N2 in response to a signal of the enable signal terminal EM. The second light-emitting control module 160 is connected to the third node N3, an anode of the light-emitting device OLED and the enable signal terminal EM, and the second light-emitting control module 160 may be configured to transmit a current signal of the third node N3 to the anode of the light-emitting device OLED in response to the signal of the enable signal terminal EM. The third reset module 170 is connected to the anode of the light-emitting device OLED, a second initialization signal terminal Vinit2 and the scan signal terminal Scan, and the third reset module 170 may be configured to transmit the second initialization signal to the anode of the light-emitting device OLED in response to the signal of the scan signal terminal Scan to reset the anode of the light-emitting device OLED.

A driving process of the pixel driving may include a refresh frame stage and a hold frame stage. The refresh frame may include a reset stage, a data writing stage, a pre-light-emitting bias stage and a light-emitting stage. The hold frame may include a reset stage, a pre-light-emitting bias stage and a light-emitting stage. That is, the hold frame does not need to write data, but instead maintains data written by the refresh frame.

The first reset module 110, the second reset module 180 and the third reset module 170 may be turned on in the reset stage. The first reset module 110 can transmit the first initialization signal to the first node N1 to reset the first node N1, the second reset module 180 can transmit the third initialization signal to the second node N2 to reset the second node N2, and the third reset module 170 can transmit the second initialization signal to the anode of the light-emitting device OLED to reset the anode of the light-emitting device OLED.

The first transmission module 120 and the data writing module 140 may be turned on in the data writing stage. In this stage, the driving module 130 is turned on under the voltage control of the first node N1, so that the data signal is written to the first node N1 through the data writing module 140, the driving module 130 and the first transmission module 120.

In the pre-light-emitting bias stage, the second reset module 180 may be controlled to be turned on to transmit the third initialization signal to the second node N2 to reset the second node N2.

The first light-emitting control module 150 and the second light-emitting control module 160 may be turned on in the light-emitting stage, so as to form a current path between the first power terminal VDD and the second power terminal VSS, and the light-emitting device OLED emits light under the action of the driving current provided by the driving module 130.

The first switch module 190 may be turned off during the reset stage of the hold frame and turned on in other stages. In this way, the preset node A can be controlled to float during the reset stage of the hold frame, so that the voltage change of the first node N1 can be coupled to the preset node A by the coupling module 200. Accordingly, the voltage of the first node N1 in the hold frame is not changed after the first node N1 is reset during the reset stage of the hold frame, that is, the operating state of the driving module 130 is not changed.

In an embodiment, the pixel driving circuit can be implemented by a transistor. For example, with continued reference to FIG. 2, the first reset module 110 may include a first transistor T1, a first electrode of the first transistor T1 is connected to the first initialization signal terminal Vinit1, a second electrode of the first transistor T1 is connected to the first node N1, and a gate of the first transistor T1 is connected to the first reset signal terminal Re-N, and the first transistor T1 may be configured to transmit the first initialization signal to the first node N1 in response to the signal of the first reset signal terminal Re-N. The first transmission module 120 may include a second transistor T2, a first electrode of the second transistor T2 is connected to the first node N1, a second electrode of the second transistor T2 is connected to the third node N3, and a gate of the second transistor T2 is connected to the first gate signal terminal Gn-N, and the second transistor T2 may be configured to turn on a connection between the third node N3 and the first node N1 in response to the signal of the first gate signal terminal Gn-N. The driving module 130 may include a driving transistor DT, a first electrode of the driving transistor DT is connected to the second node N2, a second electrode of the driving transistor DT is connected to the third node N3, and a gate of the driving transistor DT is connected to the first node N1, and the driving transistor DT may be configured to provide the driving current to the third node N3 using the voltage difference between the first node N1 and the second node N2. The first switch module 190 may include a first switch transistor Tsw1, a first electrode of the first switch transistor Tsw1 is connected to the preset node A, a second electrode of the first switch transistor Tsw1 is connected to the first power terminal VDD, and a gate of the first switch transistor Tsw1 is connected to the first switch signal terminal SW-P, and the first switch transistor Tsw1 may be configured to turn on in response to the signal of the first switch signal terminal SW-P to stabilize the preset node using the voltage signal of the first power terminal VDD or turn off in response to the signal of the first switch signal terminal SW-P to control the preset node A to float.

The second reset module 180 may include an eighth transistor T8, a first electrode of the eighth transistor T8 is connected to the third initialization signal terminal Vinit3, a second electrode of the eighth transistor T8 is connected to the second node N2, and a gate of the eighth transistor T8 is connected to the scan signal terminal Scan. The eighth transistor T8 may be configured to transmit the third initialization signal to the second node N2 in response to the signal of the scan signal terminal Scan to reset the second node N2.

The data writing module 140 may include a fourth transistor T4, a first electrode of the fourth transistor T4 is connected to the data signal terminal Vdata, a second electrode of the fourth transistor T4 is connected to the second node N2, and a gate of the fourth transistor T4 is connected to the second gate signal terminal Gn-P, and the fourth transistor T4 may be configured to transmit the data signal to the second node N2 in response to the signal of the second gate signal terminal Gn-P. The first light-emitting control module 150 may include a fifth transistor T5, a first electrode of the fifth transistor T5 is connected to the first power terminal VDD, a second electrode of the fifth transistor T5 is connected to the second node N2, and a gate of the fifth transistor T5 is connected to the enable signal terminal EM, and the fifth transistor T5 may be configured to transmit the voltage signal of the first power terminal VDD to the second node N2 in response to the signal of the enable signal terminal EM. The second light-emitting control module 160 may include a sixth transistor T6, a first electrode of the sixth transistor T6 is connected to the third node N3, a second electrode of the sixth transistor T6 is connected to the anode of the light-emitting device OLED, and a gate of the sixth transistor T6 is connected to the enable signal terminal EM, and the sixth transistor T6 may be configured to transmit the current signal of the third node N3 to the anode of the light-emitting device OLED in response to the signal of the enable signal terminal EM. The third reset module 170 may include a seventh transistor T7, a first electrode of the seventh transistor T7 is connected to the second initialization signal terminal Vinit2, a second electrode of the seventh transistor T7 is connected to the anode of the light-emitting device OLED, and a gate of the seventh transistor T7 is connected to the scan signal terminal Scan, and the seventh transistor T7 may be configured to transmit the second initialization signal to the anode of the light-emitting device OLED in response to the signal of the scan signal terminal Scan to reset the anode of the light-emitting device OLED. The coupling module 200 may include a storage capacitor Cst, a first electrode of the storage capacitor Cst is connected to the first node N1, and a second electrode of the storage capacitor Cst is connected to the preset node A.

The first transistor T1 and the second transistor T2 can both be N-type transistors, for example, N-type oxide transistors, so that a small leakage current characteristic of the oxide transistor may be configured to reduce the leakage current of the first node N1. The leakage of the pixel driving circuit is mainly caused by the leakage of the first node N1, and thus, by controlling the leakage current of the first node N1, the voltage retention of the pixel driving circuit in a long frame period can be effectively improved to avoid the brightness difference between different data frames due to the leakage. The driving transistor DT, the first switch transistor Tsw1, and the fourth transistor T4 to the eighth transistor T8 can all be P-type transistors, for example, P-type low-temperature polysilicon transistors. An electron mobility of the low-temperature polysilicon transistor is high, which is conducive to reducing the overall power consumption of the pixel driving circuit. It should be understood that in other embodiments, the above-mentioned functional modules can also be implemented by other circuit structures.

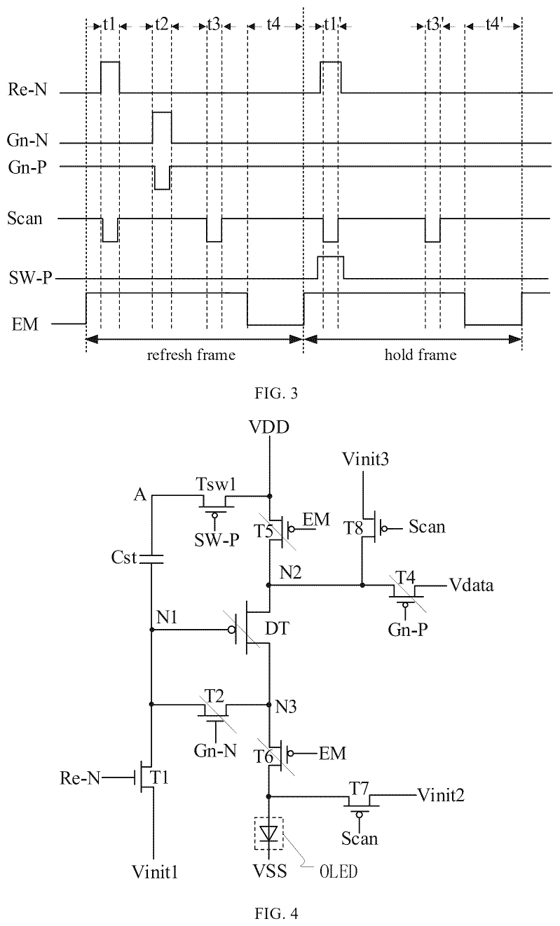

FIG. 3 is a timing diagram of respective nodes in FIG. 2, in which Re-N represents the timing of the first reset signal terminal, Gn-N represents the timing of the first gate signal terminal, Gn-P represents the timing of the second gate signal terminal, Scan represents the timing of the scan signal terminal, SW-P represents the timing of the first switch signal terminal, and EM represents the timing of the enable signal terminal.

As shown in FIG. 3, the driving process of the pixel driving may include a refresh frame and a hold frame. The refresh frame may include the reset stage, the data writing stage, the pre-light-emitting bias stage and the light-emitting stage, and the hold frame may include the reset stage, the pre-light-emitting bias stage and the light-emitting stage.

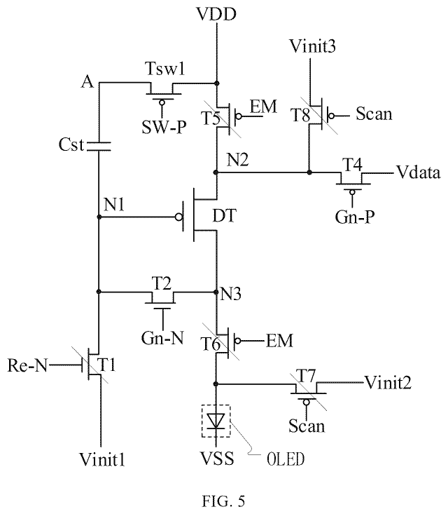

In the reset stage t1 of the refresh frame, the first reset signal terminal Re-N outputs a high-level signal, the first gate signal terminal Gn-N outputs a low-level signal, the second gate signal terminal Gn-P outputs a high-level signal, the scan signal terminal Scan outputs a low-level signal, the first switch signal terminal SW-P outputs a low-level signal, and the enable signal terminal EM outputs a high-level signal. FIG. 4 is an equivalent circuit diagram of the pixel driving circuit of FIG. 2 in a reset stage of a refresh frame. As shown in FIG. 4, the first transistor T1, the seventh transistor T7, the eighth transistor T8 and the first switch transistor Tsw1 are turned on, and other transistors are turned off. In this process, the first initialization signal is transmitted to the first node N1 to reset the first node N1, the second initialization signal is transmitted to the anode of the light-emitting device OLED to reset the anode of the light-emitting device OLED, and the third initialization signal is transmitted to the second node N2 to reset the second node N2. Accordingly, the voltage of the first node N1 becomes Vinit1, the voltage of the second node N2 becomes Vinit3, and the voltage difference between the first node N1 and the second node N2 is Vinit1−Vinit3, which is the bias voltage Vgs of the driving transistor DT.

In the data writing stage t2 of the refresh frame, the first reset signal terminal Re-N outputs a low-level signal, the first gate signal terminal Gn-N outputs a high-level signal, the second gate signal terminal Gn-P outputs a low-level signal, the scan signal terminal Scan outputs a high-level signal, the first switch signal terminal SW-P outputs a low-level signal, and the enable signal terminal EM outputs a high-level signal. FIG. 5 is an equivalent circuit diagram of the pixel driving circuit of FIG. 2 in a data writing stage of a refresh frame. As shown in FIG. 5, the second transistor T2, the fourth transistor T4 and the first switch transistor Tsw1 are turned on. In this case, the driving transistor DT is turned on under the control of the voltage difference between the first node N1 and the second node N2, that is, the bias voltage, and the data signal provided by the data signal terminal Vdata is transmitted to the first node N1. When a potential of the first node N1 becomes Vdata+Vth, where Vth is a threshold voltage of the driving transistor DT, the bias voltage Vgs of the driving transistor DT is 0. In this case, the driving transistor DT is turned off, so that the threshold voltage Vth of the driving transistor DT is written to the first node N1. This process realizes the threshold voltage compensation of the driving transistor DT.

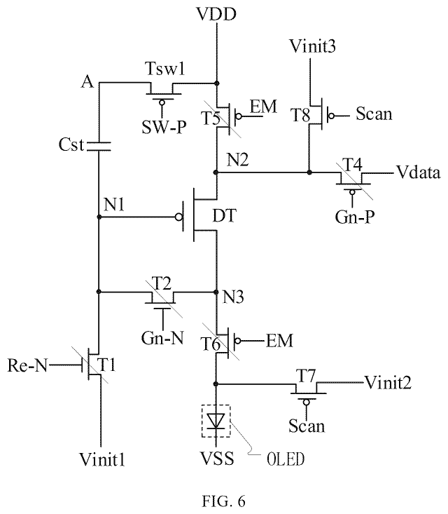

In the pre-light-emitting bias stage t3 of the refresh frame, the first reset signal terminal Re-N outputs a low-level signal, the first gate signal terminal Gn-N outputs a low-level signal, the second gate signal terminal Gn-P outputs a high-level signal, the scan signal terminal Scan outputs a low-level signal, the first switch signal terminal SW-P outputs a low-level signal, and the enable signal terminal EM outputs a high-level signal. FIG. 6 is an equivalent circuit diagram of the pixel driving circuit of FIG. 2 in a pre-light-emitting bias stage of a refresh frame. As shown in FIG. 6, the seventh transistor T7, the eighth transistor T8 and the first switch transistor Tsw1 are turned on, and the third initialization signal is transmitted to the second node N2 to reset the second node N2 once before light emitting. In this case, the bias voltage Vgs of the driving transistor DT is Vdata+Vth−Vinit3. In this embodiment, by resetting the second node N2 once using the third initialization signal before light emitting, the driving transistor DT is kept in a reset state, the hysteresis of the driving transistor DT is improved, and the residual image is eliminated. It can be known that in actual use, the hysteresis of the driving transistor DT will cause a characteristic response of the driving transistor DT to be slower. Before the light-emitting stage, a gate-source voltage of the driving transistor DT is quickly reset in this embodiment, which is beneficial to accelerate the recovery speed of the driving transistor DT. Therefore, it will improve the hysteresis phenomenon of the driving transistor DT and improve the hysteresis recovery speed.

In the light-emitting stage t4 of the refresh frame, the first reset signal terminal Re-N, the first gate signal terminal Gn-N, the first switch signal terminal SW-P, and the enable signal terminal EM all output low-level signals, and the second gate signal terminal Gn-P and the scan signal terminal Scan output high-level signals. FIG. 7 is an equivalent circuit diagram of the pixel driving circuit of FIG. 2 in a light-emitting stage of a refresh frame. As shown in FIG. 7, the fifth transistor T5, the sixth transistor T6 and the first switch transistor Tsw1 are turned on, a loop is formed from the first power terminal VDD to the second power terminal VSS, and the light-emitting device OLED emits light under the action of the driving current provided by the driving transistor DT.

$$According to the current formula : I = 1 / 2 {k ( {V}_{GS} - Vth )}^{2} \qquad ( 1 )$$

Substituting the above VGS into the equation (1), the driving current can be obtained as:

$$I = 1 / 2 {k ( V d a t a - V i n i t 3 )}^{2} \qquad ( 2 )$$

It can be seen that the driving current is only related to Vdata and Vinit3, and is not related to the voltage (driving voltage) of the first voltage terminal Vdd, thus achieving compensation of the threshold voltage and the driving voltage. Thus, driving voltages at different positions in the driving circuit will not be affected by the voltage drop of the first power line itself.

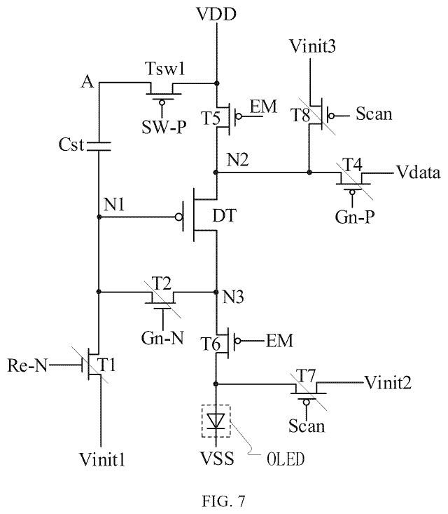

In the reset stage t1′ of the hold frame, the first reset signal terminal Re-N outputs a high-level signal, the first gate signal terminal Gn-N outputs a low-level signal, the second gate signal terminal Gn-P outputs a high-level signal, the scan signal terminal Scan outputs a low-level signal, the first switch signal terminal SW-P outputs a high-level signal, and the enable signal terminal EM outputs a high-level signal. FIG. 8 is an equivalent circuit diagram of the pixel driving circuit of FIG. 2 in a reset stage of a hold frame. As shown in FIG. 8, the seventh transistor T7, the eighth transistor T8 and the first transistor T1 are turned on. The first switch transistor Tsw1 is turned off to make the preset node A float. In addition, the first transistor T1 is turned on to write the first initialization signal to the first node N1. In this stage, the voltage change ΔVN1 of the first node N1 is Vinit1−(Vdata+Vth), and accordingly, the voltage VA of the preset node A becomes VDD+Vinit1−(Vdata+Vth). Moreover, in this stage, the voltage difference between the first node N1 and the second node N2 is Vinit1−Vinit3, that is, the bias voltage Vgs of the driving transistor DT is Vinit1−Vinit3. It can be seen that the bias voltage of the driving transistor DT is the same as the bias voltage of the driving transistor DT in the reset stage of the refresh frame, so that the driving transistor DT has the same bias voltage in the hold frame and the refresh frame, thereby eliminating or improving the difference in the display brightness between the refresh frame and the hold frame caused by the different bias voltages of the driving transistor DT.

As shown in FIG. 3, after the reset stage of the hold frame ends, the first reset signal terminal Re-N outputs a low-level signal, the scan signal terminal Scan outputs a high-level signal, the first switch signal terminal SW-P outputs a low-level signal, and output signals of other signal terminals remain unchanged relative to the previous stage. In this case, the first switch transistor Tsw1 is turned on, and accordingly, the voltage of the preset node A changes back to VDD, and the voltage change of the preset node A is ΔVA=VDD−[VDD+Vinit1−(Vdata+Vth)]=(Vdata+Vth)−Vinit1. The first transistor T1 is turned off to make the first node N1 float, and the storage capacitor Cst couples the voltage change of the preset node A to the first node N1, and the voltage of the first node N1 becomes Vdata+Vth again, which is the same as the voltage before the reset. That is, in this embodiment, the first node N1 is reset by adding the reset stage in the hold frame, which will not change the voltage of the first node N1 in the hold frame while achieving the bias voltage of the driving transistor DT to be the same as the bias voltage of the driving transistor DT in the refresh frame.

In the pre-light-emitting bias stage t3′ of the hold frame, the first reset signal terminal Re-N outputs a low-level signal, the first gate signal terminal Gn-N outputs a low-level signal, the second gate signal terminal Gn-P outputs a high-level signal, the scan signal terminal Scan outputs a low-level signal, the first switch signal terminal SW-P outputs a low-level signal, and the enable signal terminal EM outputs a high-level signal. The eighth transistor T8 is turned on to transmit the third initialization signal to the second node N2. This process is the same as the pre-light-emitting bias stage t3 of the refresh frame. The equivalent circuit diagram of this process is the same as FIG. 6, which will not be described in detail here.

In the light-emitting stage t4′ of the hold frame, the first reset signal terminal Re-N, the first gate signal terminal Gn-N, the first switch signal terminal SW-P, and the enable signal terminal EM all output low-level signals, and the second gate signal terminal Gn-P and the scan signal terminal Scan output high-level signals. The fifth transistor T5, the sixth transistor T6, and the first switch transistor Tsw1 are turned on. This process is the same as the light-emitting stage of the refresh frame, and the light-emitting device OLED emits light under the action of the driving current provided by the driving transistor DT. The equivalent circuit diagram of this process can be found in FIG. 7, which will not be repeated here.

In this embodiment, a gate reset process of the driving transistor DT is added in the hold frame, the degree of bias voltage Vgs to which the driving transistor DT is subjected is the same as the degree of bias to which the driving transistor DT is subjected in the reset stage t1 of the refreshed frame, and the bias voltages are both Vinit1−Vinit3, which is not related to the voltage of the data signal Vdata, and can effectively solve the problem of incompatibility between different brightness or high and low grayscales. In addition, after the first node N1 obtains the threshold voltage of the driving transistor DT in the data writing stage, the driving transistor DT is almost turned off, and the influence of this process on the state of the driving transistor DT is reduced. It can be seen that the pixel driving circuit and the driving method thereof in this embodiment can ensure that operating states in the refresh frame and the hold frame are consistent, thereby eliminating the brightness difference between the hold frame and the refresh frame, and improving the flickering feeling of low-frequency driving.

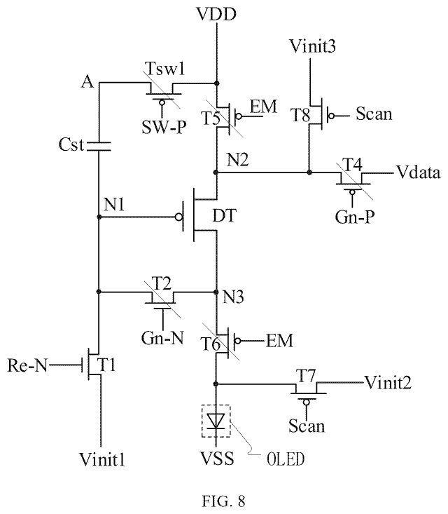

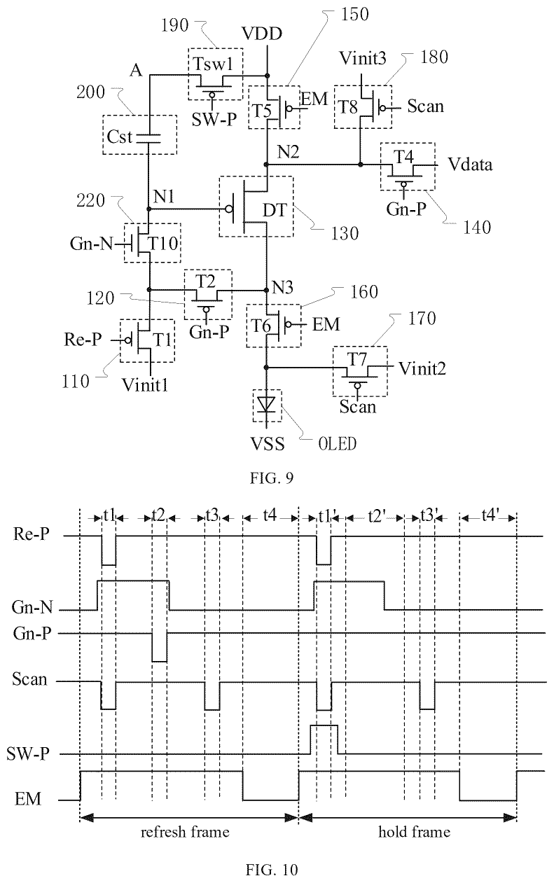

FIG. 9 is a schematic structural diagram of a pixel driving circuit according to another embodiment of the present disclosure. As shown in FIG. 9, in an embodiment, the constant voltage terminal VM is a first power terminal VDD, that is, the preset node A is connected to the first power terminal VDD through the first switch module 190. The switch signal terminal SW may include a first switch signal terminal SW-P, the reset signal terminal Re may include a second reset signal terminal Re-P, and a cathode of the light-emitting device OLED may be connected to a second power terminal VSS. The pixel driving circuit may further include a second switch module 220, which is connected in series between the first node N1 and the first reset module 110 and connected to the first gate signal terminal Gn-N. The second switch module 220 may at least be configured to connect the first reset module to the first node N1 in response to a signal of the first gate signal terminal Gn-N to transmit the first initialization signal to the first node N1.

By comparing FIG. 2 and FIG. 9, it can be seen that a difference between the pixel driving circuit in this embodiment and the pixel driving circuit shown in FIG. 2 is that in this embodiment, the second switch module 220 is added between the first reset module 110 and the first node, and on-levels of the first reset module 110 and the first transmission module 120 in this embodiment are opposite in polarity to on-levels of the first reset module 110 and the first transmission module 120 in FIG. 2. In this embodiment, the on-levels of the first reset module 110 and the first transmission module 120 are both the same in polarity as an on-level of the driving module 130, and an on-level of the second switch module 220 is opposite in polarity to the on-level of the driving module 130. For example, on-levels of the first reset module 110, the first transmission module 120 and the driving module 130 can be all low level, and the on-level of the second switch module 220 can be high level.

For example, the above functional modules can be implemented by transistors. Specifically, the first reset module 110 may include a first transistor T1, the first transmission module 120 may include a second transistor T2, the driving module 130 may include a driving transistor DT, and the second switch module 220 may include a tenth transistor T10. The first transistor T1, the second transistor T2, and the driving transistor DT may all be P-type transistors, for example, P-type low-temperature polysilicon transistors. The tenth transistor T10 may be an N-type transistor, for example, an N-type oxide transistor. By providing the tenth transistor T10 as an oxide transistor, the leakage current of the first node N1 can be reduced by utilizing the small leakage current characteristic of the oxide transistor, thereby improving the voltage retention of the pixel driving circuit in the long frame period. Other transistors are all P-type transistors, and the electron mobility of the P-type transistor is high, which can reduce the power consumption of the pixel driving circuit. In this embodiment, because the additional tenth transistor T10 is the N-type transistor, the tenth transistor T10 may be configured to reduce the leakage current of the first node N1, and accordingly, the first transistor T1 and the second transistor T2 can be provided as P-type transistors, thereby further reducing the overall power consumption of the pixel driving circuit.

It should be understood that this embodiment can also have the coupling module 200, the data writing module 140, the first light-emitting control module 150, the second light-emitting control module 160, the third reset module 170, the second reset module 180 and the first switch module 190, and the above-mentioned functional modules may have the same structure as the corresponding functional modules in FIG. 2, which will not be repeated here.

FIG. 10 is a timing diagram of respective nodes in FIG. 9, in which Re-P represents the timing of the second reset signal terminal, Gn-N represents the timing of the first gate signal terminal, Gn-P represents the timing of the second gate signal terminal, Scan represents the timing of the scan signal terminal, SW-P represents the timing of the first switch signal terminal, and EM represents the timing of the enable signal terminal.

As shown in FIG. 10, the driving process of the pixel driving may include a refresh frame and a hold frame. The refresh frame may include the reset stage, the data writing stage, the pre-light-emitting bias stage and the light-emitting stage, and the hold frame may include the reset stage, the pre-light-emitting bias stage and the light-emitting stage.

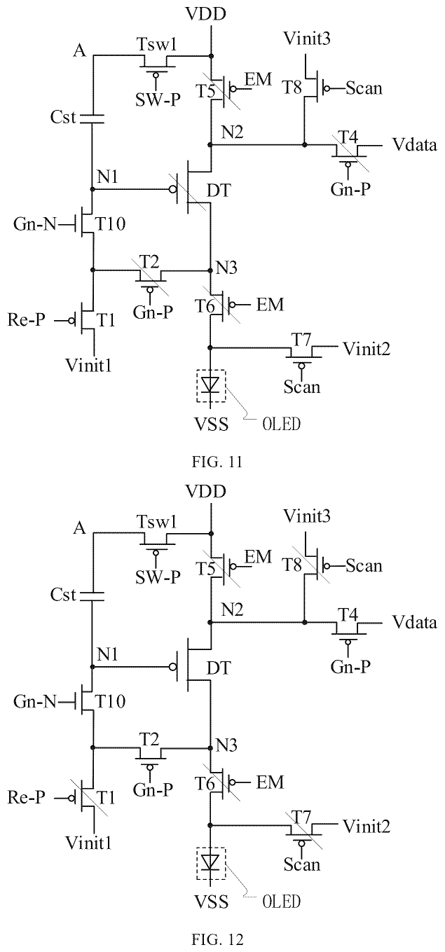

In the reset stage t1 of the refresh frame, the second reset signal terminal Re-P outputs a low-level signal, the first gate signal terminal Gn-N outputs a high-level signal, the second gate signal terminal Gn-P outputs a high-level signal, the scan signal terminal Scan outputs a low-level signal, the first switch signal terminal SW-P outputs a low-level signal, and the enable signal terminal EM outputs a high-level signal. FIG. 11 is an equivalent circuit diagram of the pixel driving circuit of FIG. 9 in a reset stage of a refresh frame. As shown in FIG. 11, the first transistor T1, the seventh transistor T7, the eighth transistor T8, the tenth transistor T10 and the first switch transistor Tsw1 are turned on, and other transistors are turned off. In this process, the first initialization signal is transmitted to the first node N1 to reset the first node N1, the second initialization signal is transmitted to the anode of the light-emitting device OLED to reset the anode of the light-emitting device OLED, and the third initialization signal is transmitted to the second node N2 to reset the second node N2. Accordingly, the voltage of the first node N1 becomes Vinit1, the voltage of the second node N2 becomes Vinit3, and the voltage difference between the first node N1 and the second node N2 is Vinit1−Vinit3, which is the bias voltage Vgs of the driving transistor DT.

In the data writing stage t2 of the refresh frame, the second reset signal terminal Re-P outputs a high-level signal, the first gate signal terminal Gn-N outputs a high-level signal, the second gate signal terminal Gn-P outputs a low-level signal, the scan signal terminal Scan outputs a high-level signal, the first switch signal terminal SW-P outputs a low-level signal, and the enable signal terminal EM outputs a high-level signal. FIG. 12 is an equivalent circuit diagram of the pixel driving circuit of FIG. 9 in a data writing stage of a refresh frame. As shown in FIG. 12, the second transistor T2, the fourth transistor T4, the tenth transistor T10 and the first switch transistor Tsw1 are turned on. In this case, the driving transistor DT is turned on under the control of the voltage difference between the first node N1 and the second node N2, that is, the bias voltage, and the data signal provided by the data signal terminal Vdata is transmitted to the first node N1. When a potential of the first node N1 becomes Vdata+Vth, where Vth is a threshold voltage of the driving transistor DT, the bias voltage Vgs of the driving transistor DT is 0. In this case, the driving transistor DT is turned off, so that the threshold voltage Vth of the driving transistor DT is written to the first node N1. This process realizes the threshold voltage compensation of the driving transistor DT.

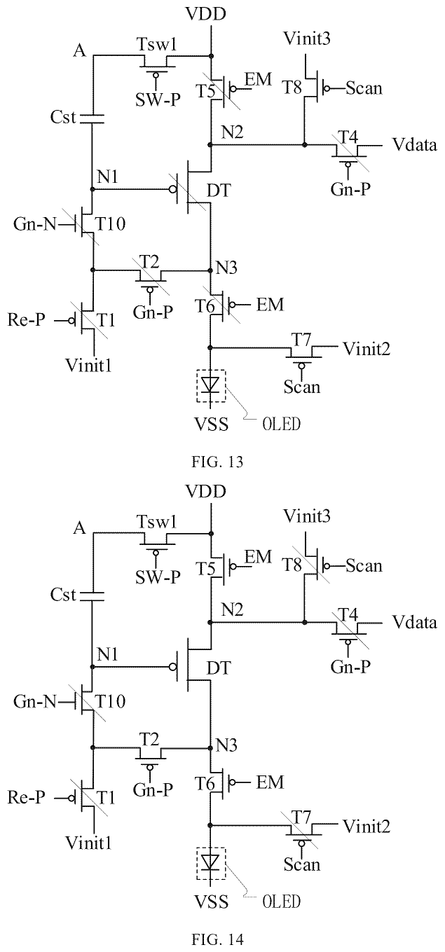

In the pre-light-emitting bias stage t3 of the refresh frame, the second reset signal terminal Re-P outputs a high-level signal, the first gate signal terminal Gn-N outputs a low-level signal, the second gate signal terminal Gn-P outputs a high-level signal, the scan signal terminal Scan outputs a low-level signal, the first switch signal terminal SW-P outputs a low-level signal, and the enable signal terminal EM outputs a high-level signal. FIG. 13 is an equivalent circuit diagram of the pixel driving circuit of FIG. 9 in a pre-light-emitting bias stage of a refresh frame. As shown in FIG. 13, the seventh transistor T7, the eighth transistor T8 and the first switch transistor Tsw1 are turned on, and the third initialization signal is transmitted to the second node N2 to reset the second node N2 and the anode of the light-emitting device OLED once before light emitting. In this case, the bias voltage Vgs of the driving transistor DT is Vdata+Vth-Vinit3. It should be understood that the pre-light-emitting bias in this embodiment can also have the effect of improving the hysteresis of the driving transistor DT and eliminating the afterimage as described in the above embodiments, which will not be repeated here.

In the light-emitting stage t4 of the refresh frame, the second reset signal terminal Re-P outputs a high-level signal, the first gate signal terminal Gn-N outputs a low-level signal, the second gate signal terminal Gn-P outputs a high-level signal, the scan signal terminal Scan outputs a high-level signal, the first switch signal terminal SW-P and the enable signal terminal EM both output low-level signals. FIG. 14 is an equivalent circuit diagram of the pixel driving circuit of FIG. 9 in a light-emitting stage. As shown in FIG. 14, the second transistor T2, the fifth transistor T5, the sixth transistor T6 and the first switch transistor Tsw1 are turned on, a loop is formed from the first power terminal VDD to the second power terminal VSS, and the light-emitting device OLED emits light under the action of the driving current provided by the driving transistor DT. This process is similar to the light-emitting process of the circuit shown in FIG. 2, which will not be repeated here.

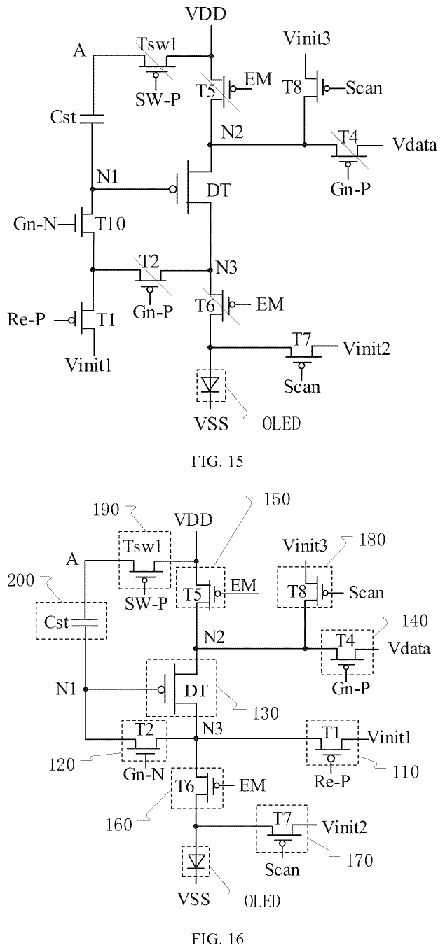

In the reset stage t′ of the hold frame, the second reset signal terminal Re-P outputs a low-level signal, the first gate signal terminal Gn-N outputs a high-level signal, the second gate signal terminal Gn-P outputs a high-level signal, the scan signal terminal Scan outputs a low-level signal, the first switch signal terminal SW-P outputs a high-level signal, and the enable signal terminal EM outputs a high-level signal. FIG. 15 is an equivalent circuit diagram of the pixel driving circuit of FIG. 9 in a reset stage of a hold frame. As shown in FIG. 15, the first transistor T1, the tenth transistor T10, the seventh transistor T7 and the eighth transistor T8 are turned on, and the first switch transistor Tsw1 is turned off to make the preset node A float. In addition, the first transistor T1 and the tenth transistor T10 are turned on to write the first initialization signal to the first node N1. In this stage, the voltage change ΔVN1 of the first node N1 is Vinit1−(Vdata+Vth), and accordingly, the voltage VA of the preset node A becomes VDD+Vinit1−(Vdata+Vth). Moreover, in this stage, the voltage difference between the first node N1 and the second node N2 is Vinit1−Vinit3, that is, the bias voltage Vgs of the driving transistor DT is Vinit1−Vinit3. It can be seen that the bias voltage of the driving transistor DT is the same as the bias voltage of the driving transistor DT in the reset stage of the refresh frame, so that the driving transistor DT has the same bias voltage in the hold frame and the refresh frame, thereby eliminating or improving the difference in the display brightness between the refresh frame and the hold frame caused by the different bias voltages of the driving transistor DT.

As shown in FIG. 10, in a second stage t2′ after the reset stage of the hold frame ends, the second reset signal terminal Re-P outputs a high-level signal, the scan signal terminal Scan outputs a high-level signal, the first switch signal terminal SW-P outputs a low-level signal, and output signals of other signal terminals remain unchanged. In this case, the first switch transistor Tsw1 is turned on, and accordingly, the voltage of the preset node A changes back to VDD, and the voltage change of the preset node A is ΔVA=VDD−(VDD+Vinit1−(Vdata+Vth))=(Vdata+Vth)−Vinit1. In addition, the first transistor T1 is turned off to make the first node N1 float, and the storage capacitor Cst couples the voltage change of the preset node A to the first node N1, and the voltage of the first node N1 becomes Vdata+Vth again, which is the same as the voltage before reset. It can be seen that in this embodiment, the first node N1 is reset by adding the reset stage in the hold frame, which will not change the voltage of the first node N1 in the hold frame while achieving the bias voltage of the driving transistor DT to be the same as the bias voltage of the driving transistor DT in the refresh frame.

The following pre-light-emitting bias stage t3′ of the hold frame is the same as the pre-light-emitting bias stage t3 of the refresh frame, and the light-emitting stage t4′ of the hold frame is the same as the light-emitting stage t4 of the refresh frame, which will not be described in detail here.

It can be seen that this embodiment can also achieve the same bias voltage of the driving transistor DT in the hold frame and the refresh frame by adding the second switch module 200 between the first node N1 and the first reset module 110 and coordinating with the corresponding timing, thereby solving the problem of uneven display brightness between the hold frame and the refresh frame.

FIG. 16 is a schematic structural diagram of a pixel driving circuit according to another embodiment of the present disclosure. As shown in FIG. 16, in an embodiment, the constant voltage terminal VM is a first power terminal VDD, that is, the preset node A is connected to the first power terminal VDD through the first switch module 190. The switch signal terminal SW may include a first switch signal terminal SW-P, the reset signal terminal Re may include a second reset signal terminal Re-P, and a cathode of the light-emitting device OLED may be connected to a second power terminal VSS. The first reset module 110 may also be connected to the first node N1 through the first transmission module 120. In this case, the first reset module 110 is connected to the third node N3, the first initialization signal terminal Vinit1 and the second reset signal terminal Re-P, and the first transmission module 120 is connected between the first node N1 and the third node N3 and connected to the first gate signal terminal Gn-N. Under this circuit structure, an on-level of the first transmission module 120 is opposite in polarity to an on-level of the driving module 103.

For example, the first transmission module 120 may include a second transistor T2, the driving module 103 may include a driving transistor T3, the second transistor T2 may be an N-type transistor, for example, an N-type oxide transistor, and the driving transistor DT may be a P-type transistor, for example, a P-type low-temperature polysilicon transistor. In this case, by providing the second transistor T2 as an oxide transistor, the leakage current of the first node N1 can be reduced, and the voltage retention of the pixel driving circuit can be improved on the basis of simplifying the circuit structure.

As shown in FIG. 16, the pixel driving circuit shown in this embodiment may also include the coupling module 200, the data writing module 140, the first light-emitting control module 150, the second light-emitting control module 160, the third reset module 170, the second reset module 180 and the first switch module 190, and the above-mentioned functional modules may have the same structure as the corresponding functional modules in FIG. 2, which will not be repeated here.

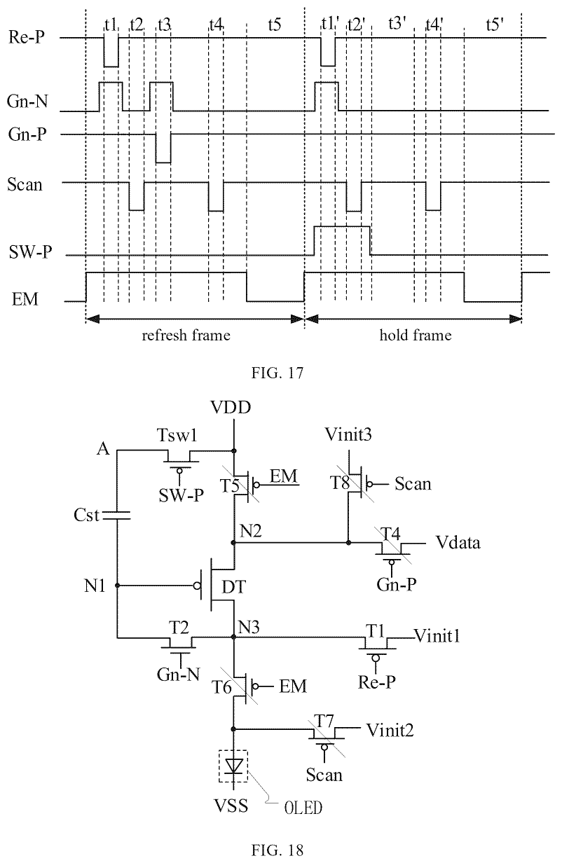

FIG. 17 is a timing diagram of respective nodes in FIG. 16, in which Re-P represents the timing of the second reset signal terminal, Gn-N represents the timing of the first gate signal terminal, Gn-P represents the timing of the second gate signal terminal, Scan represents the timing of the scan signal terminal, SW-P represents the timing of the first switch signal terminal, and EM represents the timing of the enable signal terminal EM. In addition, the driving process of the pixel driving may include a refresh frame and a hold frame. The refresh frame may include the reset stage, the data writing stage, the pre-light-emitting bias stage and the light-emitting stage, and the hold frame may include the reset stage, the pre-light-emitting bias stage and the light-emitting stage. In addition, since the first transistor T1 is connected to the third node N3 and the eighth transistor T8 is connected to the second node N2, it is necessary to reset the second node N2 and the third node N3 in a time-division manner to prevent the second node N2 and the third node N3 from being short-circuited when they are reset at the same time. Therefore, the reset stage in this embodiment may include a first reset stage and a second reset stage.

In a first reset stage t1 of the refresh frame, the second reset signal terminal Re-P outputs a low-level signal, the first gate signal terminal Gn-N outputs a high-level signal, the second gate signal terminal Gn-P outputs a high-level signal, the scan signal terminal Scan outputs a high-level signal, the first switch signal terminal SW-P outputs a low-level signal, and the enable signal terminal EM outputs a high-level signal. FIG. 18 is an equivalent circuit diagram of the pixel driving circuit of FIG. 16 in a first reset stage of a refresh frame. As shown in FIG. 18, the first transistor T1, the second transistor T2 and the first switch transistor Tsw1 are turned on, and other transistors are turned off. In this process, the first initialization signal is transmitted to the first node N1 to reset the first node N1, so that the voltage of the first node N1 becomes Vinit1.

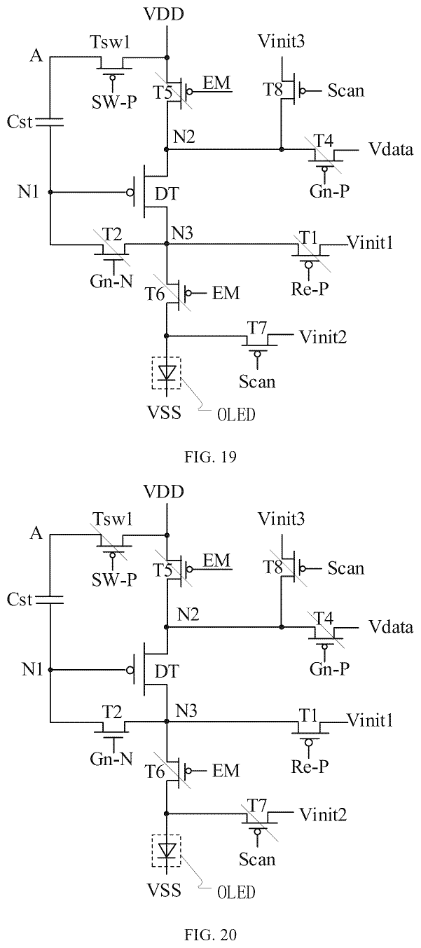

In a second reset stage t2 of the refresh frame, the second reset signal terminal Re-P outputs a high-level signal, the first gate signal terminal Gn-N outputs a low-level signal, the second gate signal terminal Gn-P outputs a high-level signal, the scan signal terminal Scan outputs a low-level signal, the first switch signal terminal SW-P outputs a low-level signal, and the enable signal terminal EM outputs a high-level signal. FIG. 19 is an equivalent circuit diagram of the pixel driving circuit of FIG. 16 in a second reset stage of a refresh frame. As shown in FIG. 19, the seventh transistor T7, the eighth transistor T8 and the first switch transistor Tsw1 are turned on, and other transistors are turned off. The second initialization signal is transmitted to the anode of the light-emitting device OLED to reset the anode of the light-emitting device OLED, the third initialization signal is transmitted to the second node N2 to reset the second node N2, and the voltage of the second node N2 becomes Vinit3, so that the voltage difference between the first node N1 and the second node N2 is Vinit1−Vinit3, which is the bias voltage Vgs of the driving transistor DT.

The following pre-light-emitting bias stage and the light-emitting stage of the refresh frame correspond to the pre-light-emitting bias stage and the light-emitting stage of the driving method shown in FIG. 3, and have the same effect, which will not be described in detail here.

In the reset stage t1′ of the hold frame, the second reset signal terminal Re-P outputs a low-level signal, the first gate signal terminal Gn-N outputs a high-level signal, the second gate signal terminal Gn-P outputs a high-level signal, the scan signal terminal Scan outputs a high-level signal, the first switch signal terminal SW-P outputs a high-level signal, and the enable signal terminal EM outputs a high-level signal. FIG. 20 is an equivalent circuit diagram of the pixel driving circuit of FIG. 16 in a first reset stage of a hold frame. As shown in FIG. 20, the first transistor T1 and the second transistor T2 are turned on, and other transistors are turned off. In this process, the first initialization signal is transmitted to the first node N1 to reset the first node N1, so that the voltage of the first node N1 becomes Vinit1, and the voltage change ΔVN1 of the first node N1 is Vinit1−(Vdata+Vth), and at this stage, the first switch transistor Tsw1 is turned off to make the preset node A float, and accordingly, the storage capacitor Cst couples the voltage change ΔVN1 of the first node A to the preset node A, so that the voltage VA of the preset node A becomes VDD+Vinit1−(Vdata+Vth).

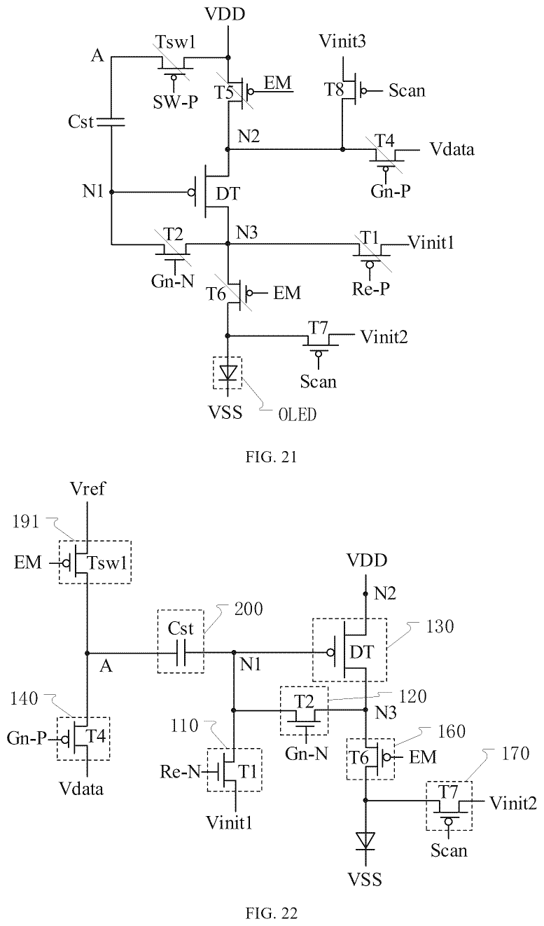

In the second reset stage t2′ of the hold frame, the second reset signal terminal Re-P outputs a high-level signal, the first gate signal terminal Gn-N outputs a low-level signal, the second gate signal terminal Gn-P outputs a high-level signal, the scan signal terminal Scan outputs a low-level signal, the first switch signal terminal SW-P outputs a high-level signal, and the enable signal terminal EM outputs a high-level signal. FIG. 21 is an equivalent circuit diagram of the pixel driving circuit of FIG. 16 in a second reset stage of a hold frame. As shown in FIG. 21, the seventh transistor T7 and the eighth transistor T8 are turned on, and other transistors are turned off. The second initialization signal is transmitted to the anode of the light-emitting device OLED to reset the anode of the light-emitting device OLED, the third initialization signal is transmitted to the second node N2 to reset the second node N2, and the voltage of the second node N2 becomes Vinit3, so that the voltage difference between the first node N1 and the second node N2 is Vinit1−Vinit3, which is the bias voltage Vgs of the driving transistor DT. It can be seen that the bias voltage of the driving transistor DT is the same as the bias voltage of the driving transistor DT in the reset stage of the refresh frame, so that the driving transistor DT has the same bias voltage in the hold frame and the refresh frame, thereby eliminating or improving the difference in the display brightness between the refresh frame and the hold frame caused by the different bias voltages of the driving transistor DT. In this process, the first switch transistor Tsw1 is turned off, and the preset node A maintains the voltage of the previous stage.

Then, as shown in FIG. 17, in a third stage t3′ after the second reset stage of the hold frame ends, the scan signal terminal Scan outputs a high-level signal, the first switch signal terminal SW-P outputs a low-level signal, and output signals of other signal terminals are the same as output signals of the previous stage. In this case, the first switch transistor Tsw1 is turned on, and accordingly, the voltage of the preset node A changes back to VDD, and the voltage change of the preset node A is ΔVA=VDD−[VDD+Vinit1−(Vdata+Vth)]. In addition, the first node N1 is floating, and the storage capacitor Cst couples the voltage change of the preset node A to the first node N1, and the voltage of the first node N1 becomes Vdata+Vth again, which is the same as the voltage before the reset. That is, in this embodiment, the first node N1 is reset by adding the reset stage in the hold frame, which will not change the voltage of the first node N1 in the hold frame while achieving the bias voltage of the driving transistor DT to be the same as the bias voltage of the driving transistor DT in the refresh frame.

Similarly, the pre-light-emitting bias stage and the light-emitting stage of the hold frame correspond to the pre-light-emitting bias stage and the light-emitting stage of the refresh frame and have the same effect, which will not be repeated here.

FIG. 22 is a structural schematic diagram of a pixel driving circuit according to another embodiment of the present disclosure. As shown in FIG. 22, in an embodiment, the constant voltage terminal VM is a reference voltage terminal Vref, that is, the preset node A is connected to the reference voltage terminal Vref through the first switch module 190. The switch signal terminal SW may include a second switch signal terminal, the reset signal terminal Re may include a first reset signal terminal Re-N and a second reset signal terminal Re-P, a cathode of the light-emitting device OLED may be connected to a second power terminal VSS, and the second node N2 may be directly connected to the first power terminal VDD. In this embodiment, the first switch module 190 may include a first sub-switch module 191, and the second switch signal terminal may reuse the enable signal terminal EM, that is, the first sub-switch module 191 is connected between the reference voltage terminal Vref and the preset node A and is further connected to the enable signal terminal EM, so that the first sub-switch module 191 may be turned on in response to a signal of the enable signal terminal EM to stabilize the preset node A using a voltage signal of the reference voltage terminal Vref or turned off in response to the signal of the enable signal terminal EM to control the preset node A to float. In this embodiment, the first sub-switch module 191 can be turned on in the reset stage and the light-emitting stage, respectively, so as to stabilize the preset node A using the reference voltage terminal Vref.

As shown in FIG. 22, in an embodiment, the pixel driving circuit may further include a first transmission module 120, a data writing module 140, a second light emitting control module 160, and a third reset module 170. The first transmission module 120 is connected to the first node N1, the third node N3, and the first gate signal terminal Gn-N, and the first transmission module 120 may be configured to turn on or turn off the connection between the first node N1 and the third node N3 in response to a signal of the first gate signal terminal Gn-N. On-levels of the first transmission module 120 and the first reset module 110 are opposite in polarity to an on-level of the driving module 130. For example, if the on-level of the driving module 130 is high level, the on-levels of the first transmission module 120 and the first reset module 110 may be low level.

The data writing module 140 is connected to the preset node A, the data signal terminal Vdata and the second gate signal terminal Gn-P. The data writing module 140 may be configured to transmit the signal of the data signal terminal Vdata to the preset node A in response to the signal of the second gate signal terminal Gn-P. The second light-emitting control module 160 is connected to a third node N3, an anode of the light-emitting device OLED and the enable signal terminal EM. The second light-emitting control module 160 may be configured to transmit the driving current of the third node N3 to the anode of the light-emitting device OLED in response to the signal of the enable signal terminal EM. The third reset module 170 is connected to the anode of the light-emitting device OLED, the second initialization signal terminal Vinit2 and the scan signal terminal Scan. The third reset module 170 may be configured to transmit the second initialization signal to the anode of the light-emitting device OLED in response to the signal of the scan signal terminal Scan to reset the anode of the light-emitting device OLED.

In an embodiment, the first reset module 110, the first transmission module 120, the driving module 130, the first sub-switch module 191, the data writing module 140, the second light emission control module 160 and the third reset module 170 may all be implemented by transistors. As shown in FIG. 22, the first reset module 110 may include a first transistor T1, a first electrode of the first transistor T1 is connected to the first initialization signal terminal Vinit1, a second electrode of the first transistor T1 is connected to the first node N1, and a gate of the first transistor T1 is connected to the first reset signal terminal Re-N, and the first transistor T1 may be configured to transmit the first initialization signal to the first node N1 in response to the signal of the first reset signal terminal Re-N. The first transmission module 120 may include a second transistor T2, a first electrode of the second transistor T2 is connected to the first node N1, a second electrode of the second transistor T2 is connected to the third node N3, and a gate of the second transistor T2 is connected to the first gate signal terminal Gn-N, and the second transistor T2 may be configured to turn on a connection between the third node N3 and the first node N1 in response to the signal of the first gate signal terminal Gn-N. The driving module 130 may include a driving transistor DT, a first electrode of the driving transistor DT is connected to the second node N2, a second electrode of the driving transistor DT is connected to the third node N3, and a gate of the driving transistor DT is connected to the first node N1, and the driving transistor DT may be configured to provide the driving current to the third node N3 using the voltage difference between the first node N1 and the second node N2. The driving transistor DT can be a P-type transistor, for example, a P-type low-temperature polysilicon transistor. The first transistor T1 and the second transistor T2 can be N-type transistors, for example, N-type oxide transistors. The leakage current of the oxide transistor is small, and by providing the first transistor T1 and the second transistor T2 as N-type transistors, the leakage current of the first node N1 can be reduced, thereby improving the data voltage retention of the pixel driving circuit. It should be understood that in other embodiments, the first reset module 110, the first transmission module 120 and the driving module 130 can also be implemented by other circuit structures.

The first sub-switch module 191 may include a first switch transistor Tsw1, a first electrode of the first switch transistor Tsw1 is connected to the reference voltage terminal Vref, a second electrode of the first switch transistor Tsw1 is connected to the preset node A, and a gate of the first switch transistor Tsw1 is connected to the enable signal terminal EM.

The data writing module 140 may include a fourth transistor T4, a first electrode of the fourth transistor T4 is connected to the data signal terminal Vdata, a second electrode of the fourth transistor T4 is connected to the preset node A, and a gate of the fourth transistor T4 is connected to the second gate signal terminal Gn-P, and the fourth transistor T4 may be configured to transmit the signal of the data signal terminal Vdata to the preset node A in response to the signal of the second gate signal terminal Gn-P. The second light-emitting control module 160 may include a sixth transistor T6, a first electrode of the sixth transistor T6 is connected to the third node N3, a second electrode of the sixth transistor T6 is connected to the anode of the light-emitting device OLED, and a gate of the sixth transistor T6 is connected to the enable signal terminal EM, and the sixth transistor T6 may be configured to transmit the driving current of the third node N3 to the anode of the light-emitting device OLED in response to the signal of the enable signal terminal EM. The third reset module 170 may include a seventh transistor T7, a first electrode of the seventh transistor T7 is connected to the second initialization signal terminal Vinit2, a second electrode of the seventh transistor T7 is connected to the anode of the light-emitting device OLED, and a gate of the seventh transistor T7 is connected to the scan signal terminal Scan, and the seventh transistor T7 may be configured to transmit the second initialization signal to the anode of the light-emitting device OLED in response to the signal of the scan signal terminal Scan to reset the anode of the light-emitting device OLED. In this embodiment, the fourth transistor T4, the sixth transistor T6, the seventh transistor T7, and the first switch transistor Tsw1 can all be P-type transistors, which is beneficial to reducing the overall power consumption of the pixel driving circuit. In addition, the coupling module 200 may include a storage capacitor Cst, a first electrode of the storage capacitor Cst is connected to the first node N1, and a second electrode of the storage capacitor Cst is connected to the preset node A.

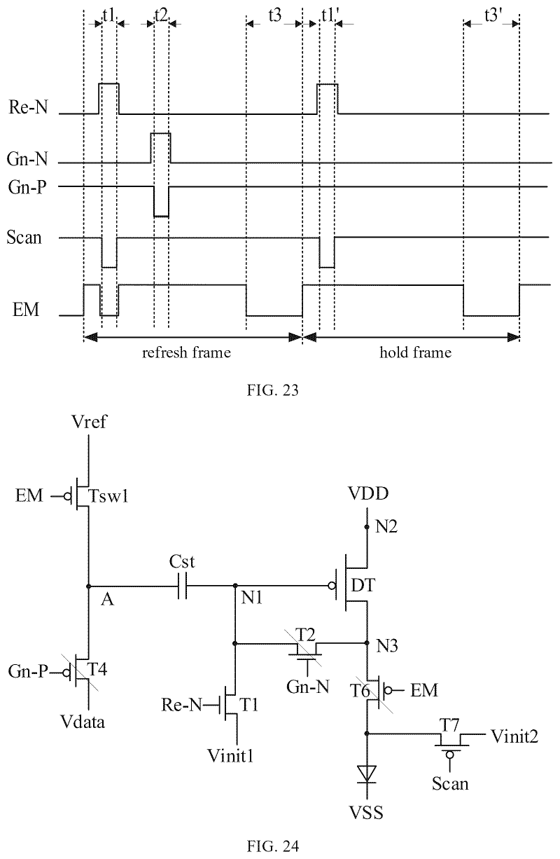

FIG. 23 is a timing diagram of respective nodes of the pixel driving circuit shown in FIG. 22, in which Re-N represents the timing of the first reset signal terminal, Gn-N represents the timing of the first gate signal terminal, Gn-P represents the timing of the second gate signal terminal, Scan represents the timing of the scan signal terminal, and EM represents the timing of the enable signal terminal. The driving process of the pixel driving may include a refresh frame and a hold frame, the refresh frame may include a reset stage, a data writing stage, and a light-emitting stage, and the hold frame may include a reset stage and a light-emitting stage.

As shown in FIG. 23, in the reset stage t1 of the refresh frame, the first reset signal terminal Re-N outputs a high-level signal, the first gate signal terminal Gn-N outputs a low-level signal, the second gate signal terminal Gn-P outputs a high-level signal, the scan signal terminal Scan outputs a low-level signal, and the enable signal terminal EM outputs a low-level signal. FIG. 24 is an equivalent circuit diagram of the pixel driving circuit of FIG. 22 in a reset stage of a refresh frame. As shown in FIG. 24, the first transistor T1, the seventh transistor T7 and the first switch transistor Tsw1 are turned on, and other transistors are turned off. In this process, the voltage of the preset node A is Vref, the first initialization signal is transmitted to the first node N1 to reset the first node N1, and the second initialization signal is transmitted to the anode of the light-emitting device OLED to reset the anode of the light-emitting device OLED, so that the voltage of the first node N1 becomes Vinit1, and the voltage difference between the first node N1 and the second node N2 is Vinit1−VDD, which is the bias voltage Vgs of the driving transistor DT.

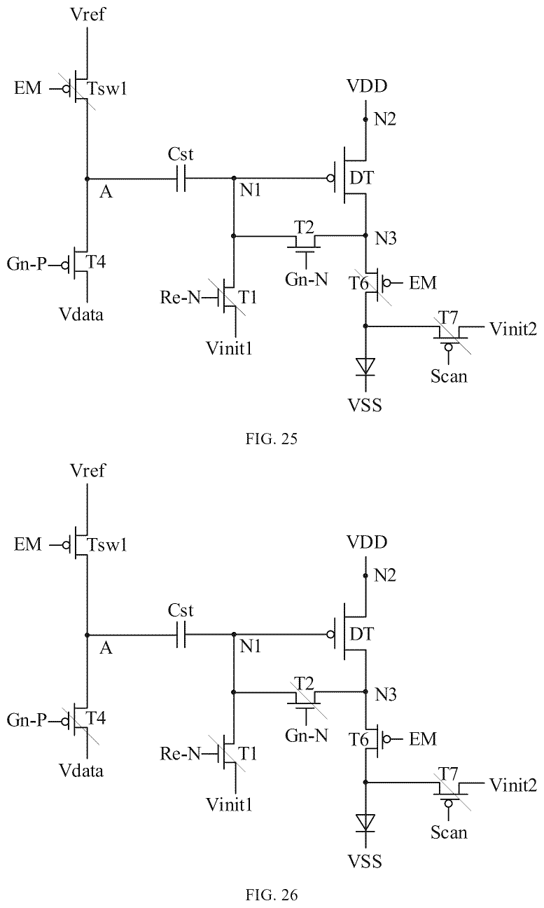

In the data writing stage t2 of the refresh frame, the first reset signal terminal Re-N outputs a low-level signal, the first gate signal terminal Gn-N outputs a high-level signal, the second gate signal terminal Gn-P outputs a low-level signal, the scan signal terminal Scan outputs a high-level signal, and the enable signal terminal EM outputs a high-level signal. FIG. 25 is an equivalent circuit diagram of the pixel driving circuit of FIG. 22 in a data writing stage of a refresh frame. As shown in FIG. 25, the second transistor T2 and the fourth transistor T4 are turned on. In this case, the data signal provided by the data signal terminal Vdata is written to the preset node A. The driving transistor DT is turned on under the control of the voltage difference between the first node N1 and the second node N2, that is, the bias voltage. When the potential of the first node N1 becomes VDD+Vth, (Vth is the threshold voltage of the driving transistor DT), the bias voltage Vgs of the driving transistor DT is 0. In this case, the driving transistor DT is turned off, so that the threshold voltage Vth of the driving transistor DT is written to the first node N1.

In the light-emitting stage t3 of the refresh frame, the first reset signal terminal Re-N outputs a low-level signal, the first gate signal terminal Gn-N outputs a low-level signal, the second gate signal terminal Gn-P outputs a high-level signal, the scan signal terminal Scan outputs a high-level signal, and the enable signal terminal EM outputs a low-level signal. FIG. 26 is an equivalent circuit diagram of the pixel driving circuit of FIG. 22 in a light-emitting stage of a refresh frame. As shown in FIG. 26, the first switch transistor Tsw1 and the sixth transistor T6 are turned on, the reference voltage signal Vref is written to the preset node A, and the voltage change ΔVA of the preset node A is Vref-Vdata. In addition, the first node N1 is floating, and the storage capacitor Cst couples the voltage change ΔVA of the preset node A to the first node N1, so that the voltage of the first node N1 becomes Vn1=VDD+Vth+(Vref−Vdata), a loop is formed from the first power terminal VDD to the second power terminal VSS, and the light-emitting device OLED emits light under the driving current provided by the driving transistor DT.

$$According to the current formula : I = 1 / 2 {k ( {V}_{GS} - Vth )}^{2} \qquad ( 1 )$$

Substituting the above VGS into the equation (1), the driving current can be obtained as:

$$I = 1 / 2 {k ( Vref - Vdata )}^{2} \qquad ( 2 )$$

It can be seen that the driving current is only related to the reference voltage Vref and the data voltage Vdata, and is not related to the voltage (driving voltage) of the first voltage terminal Vdd, thereby achieving compensation of the threshold voltage and the driving voltage. Therefore, driving voltages at different positions of the driving circuit will not be affected by a voltage drop of the first power line itself, thereby achieving IR drop compensation on the first power line.

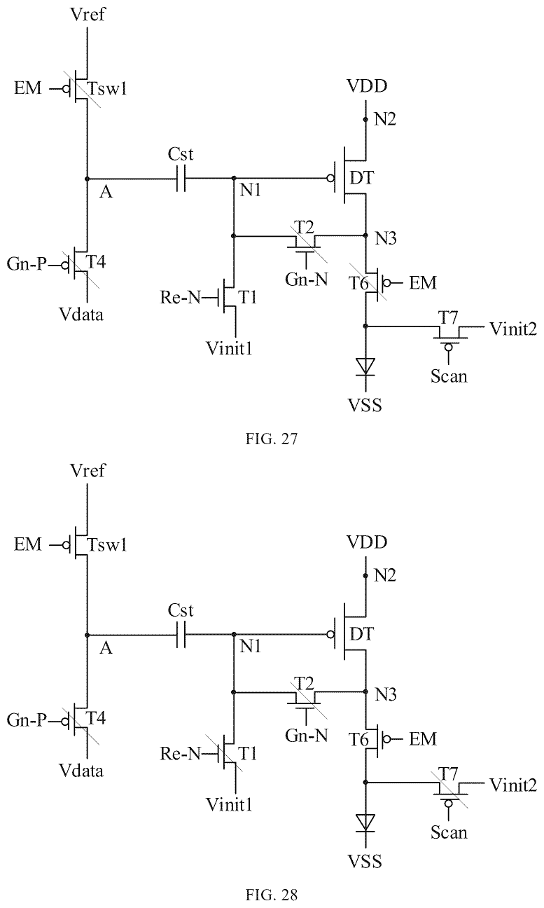

In the reset stage t1′ of the hold frame, the first reset signal terminal Re-N outputs a high-level signal, the first gate signal terminal Gn-N outputs a low-level signal, the second gate signal terminal Gn-P outputs a high-level signal, the scan signal terminal Scan outputs a low-level signal, and the enable signal terminal EM outputs a high-level signal. FIG. 27 is an equivalent circuit diagram of the pixel driving circuit of FIG. 22 in a reset stage of a hold frame. As shown in FIG. 27, the first transistor T1 and the seventh transistor T7 are turned on, and other transistors are turned off. The preset node A is floating, and the first transistor T1 is turned on to write the first initialization signal to the first node N1. In this stage, the voltage change ΔVN1 of the first node N1 is Vinit1−[VDD+Vth+(Vref−Vdata)], and the storage capacitor Cst couples this voltage change to the preset node A, and accordingly, the voltage VA of the preset node A becomes Vref+Vinit1−[VDD+Vth+(Vref−Vdata)]. In this case, the voltage difference between the first node N1 and the second node N2 is Vinit1−VDD, that is, the bias voltage Vgs of the driving transistor DT is Vinit1−VDD. It can be seen that the bias voltage of the driving transistor DT is the same as the bias voltage of the driving transistor DT in the reset stage of the refresh frame, so that the driving transistor DT has the same bias voltage in the hold frame and the refresh frame, thereby eliminating or improving the difference in the display brightness between the refresh frame and the hold frame caused by the different bias voltages of the driving transistor DT.

In the light-emitting stage t3′ of the hold frame, the second reset signal terminal Re-P outputs a high-level signal, the first reset signal terminal Re-N outputs a low-level signal, the first gate signal terminal Gn-N outputs a low-level signal, the second gate signal terminal Gn-P outputs a high-level signal, the scan signal terminal Scan outputs a high-level signal, and the enable signal terminal EM outputs a low-level signal. FIG. 28 is an equivalent circuit diagram of the pixel driving circuit of FIG. 22 in a light-emitting stage of a hold frame. As shown in FIG. 28, the first switch transistor Tsw1 and the sixth transistor T6 are turned on, the reference voltage signal Vref is written to the preset node A, the voltage of the preset node A changes back to Vref, and the voltage change of the preset node A is ΔVA=Vref−[Vref+Vinit1−[VDD+Vth+(Vref−Vdata)]]=[VDD+Vth+(Vref−Vdata)]−Vinit1. In addition, the first node N1 is floating, and the storage capacitor Cst couples the voltage change ΔVA of the preset node A to the first node N1, so that the voltage of the first node N1 becomes VN1=VDD+Vth+(Vref−Vdata), which is the same as the voltage in the light-emitting stage of the refresh frame, and the light-emitting device OLED emits light under the action of the driving current provided by the driving transistor DT.

It can be seen that in the pixel driving circuit provided by this embodiment, by adding a gate reset process of the driving transistor DT in the hold frame, the degree of bias voltage Vgs to which the driving transistor DT is subjected is the same as the degree of bias to which the driving transistor DT is subjected in the reset stage t1 of the refreshed frame, and the bias voltages are both Vinit1−VDD, which is not related to the voltage of the data signal Vdata, and can effectively solve the problem of incompatibility between different brightness or high and low grayscales. In addition, after the first node N1 obtains the threshold voltage of the driving transistor DT in the data writing stage, the driving transistor DT is almost turned off, and the influence of this process on the state of the driving transistor DT is reduced. Therefore, the pixel driving circuit and the driving method thereof in this embodiment can ensure that operating states in the refresh frame and the hold frame are consistent, thereby eliminating the brightness difference between the hold frame and the refresh frame, and improving the flickering feeling of low-frequency driving.

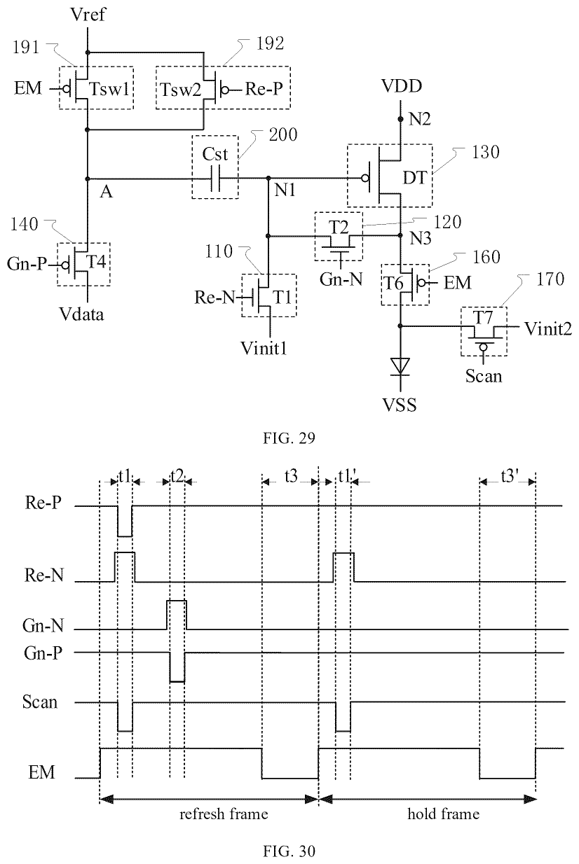

FIG. 29 is a schematic structural diagram of a pixel driving circuit according to another embodiment of the present disclosure. As shown in FIG. 29, in an embodiment, the constant voltage terminal VM is a reference voltage terminal Vref, that is, the preset node A is connected to the reference voltage terminal Vref through the first switch module 190. The switch signal terminal SW may include a first switch signal terminal and a second switch signal terminal, the reset signal terminal Re may include a first reset signal terminal Re-N and a second reset signal terminal Re-P, the first switch signal terminal may reuse the second reset signal terminal Re-P, and the second switch signal terminal may reuse the enable signal terminal. A cathode of the light-emitting device OLED may be connected to the second power terminal VSS, and the second node N2 may be directly connected to the first power terminal VDD. The first switch module 190 may include a first sub-switch module 191 and a second sub-switch module 192. The first sub-switch module 191 is connected to the reference voltage terminal Vref, the preset node A and the enable signal terminal EM. In this circuit structure, the first sub-switch module 191 may be turned on in the light-emitting stage, that is, in the light-emitting stage, the first sub-switch module 191 is turned on in response to the signal of the enable signal terminal EM to stabilize the preset node A using the voltage signal of the reference voltage terminal Vref, so that the coupling module 200 can couple the voltage change of the preset node A to the first node N1. The second sub-switch module 192 is connected to the reference voltage terminal Vref, the preset node A and the second reset signal terminal Re-P. The second sub-switch module 192 may be configured to turn on in response to the signal of the second reset signal terminal Re-P to stabilize the preset node A using the voltage signal of the reference voltage terminal Vref or turn off in response to the signal of the second reset signal terminal Re-P to control the preset node A to float.

A difference between the circuit in this embedment and the circuit shown in FIG. 22 is that this embodiment adds the second sub-switch module 192, which is turned on in the reset stage to stabilize the preset node A using the reference voltage terminal Vref, and the first sub-switch module 191 may be turned on only in the light-emitting stage.

As shown in FIG. 29, in this embodiment, the pixel driving circuit may also include the first transmission module 120, the data writing module 140, the second light-emitting control module 160 and the third reset module 170, and the pixel driving circuit may also be implemented by a transistor. It should be noted that the first reset module 110, the driving module 130, the first sub-switch module 191, the first transmission module 120, the data writing module 140, the second light-emitting control module 160 and the third reset module 170 in this embodiment may have the same circuit structure as the corresponding modules in FIG. 22.

As shown in FIG. 29, in this embodiment, the first sub-switch module 191 may include a first switch transistor Tsw1, and the second sub-switch module 192 may include a second switch transistor Tsw2. The second switch transistor Tsw2 may be a P-type transistor, a first electrode of the second switch transistor Tsw2 is connected to the reference voltage terminal Vref, a second electrode of the second switch transistor Tsw2 is connected to the preset node A, and a gate of the second switch transistor Tsw2 is connected to the second reset signal terminal Re-P, and the second switch transistor Tsw2 may be configured to transmit the voltage signal of the reference voltage terminal Vref to the preset node A in response to the signal of the second reset signal terminal Re-P to stabilize the preset node A using the reference voltage signal, or configured to turn off in response to the signal of the second reset signal terminal Re-P to control the preset node A to float. Under this circuit structure, the first switch transistor Tsw1 may be turned on in the light-emitting stage to couple the voltage change of the preset node A to the first node N1 through the coupling effect of the storage capacitor Cst.

FIG. 30 is a timing diagram of respective nodes of the pixel driving circuit shown in FIG. 29, in which Re-P represents the timing of the second reset signal terminal, Re-N represents the timing of the first reset signal terminal, Gn-N represents the timing of the first gate signal terminal, Gn-P represents the timing of the second gate signal terminal, Scan represents the timing of the scan signal terminal, and EM represents the timing of the enable signal terminal. The driving process of the pixel driving may include a refresh frame and a hold frame, the refresh frame may include a reset stage, a data writing stage, and a light-emitting stage, and the hold frame may include a reset stage and a light-emitting stage.

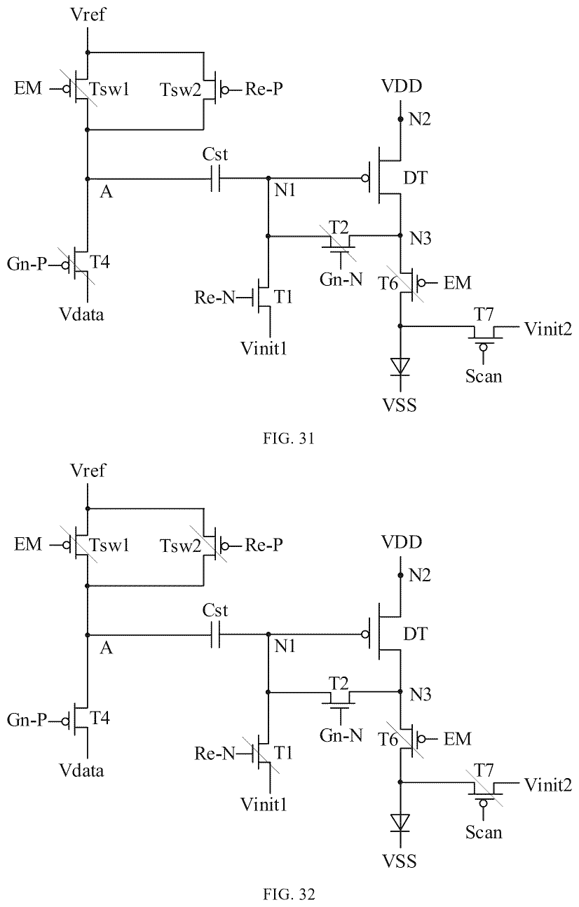

As shown in FIG. 30, in the reset stage t1 of the refresh frame, the second reset signal terminal Re-P outputs a low-level signal, the first reset signal terminal Re-N outputs a high-level signal, the first gate signal terminal Gn-N outputs a low-level signal, the second gate signal terminal Gn-P outputs a high-level signal, the scan signal terminal Scan outputs a low-level signal, and the enable signal terminal EM outputs a high-level signal. FIG. 31 is an equivalent circuit diagram of the pixel driving circuit of FIG. 29 in a reset stage of a refresh frame. As shown in FIG. 31, the first transistor T1, the seventh transistor T7 and the second switch transistor Tsw2 are turned on, and other transistors are turned off. In this process, the voltage of the preset node A is Vref, the first initialization signal is transmitted to the first node N1 to reset the first node N1, and the second initialization signal is transmitted to the anode of the light-emitting device OLED to reset the anode of the light-emitting device OLED, so that the voltage of the first node N1 becomes Vinit1, and the voltage difference between the first node N1 and the second node N2 is Vinit1−VDD, which is the bias voltage Vgs of the driving transistor DT.

In the data writing stage t2 of the refresh frame, the second reset signal terminal Re-P outputs a high-level signal, the first reset signal terminal Re-N outputs a low-level signal, the first gate signal terminal Gn-N outputs a high-level signal, the second gate signal terminal Gn-P outputs a low-level signal, the scan signal terminal Scan outputs a high-level signal, and the enable signal terminal EM outputs a high-level signal. FIG. 32 is an equivalent circuit diagram of the pixel driving circuit of FIG. 29 in a data writing stage of a refresh frame. As shown in FIG. 32, the second transistor T2 and the fourth transistor T4 are turned on. In this case, the data signal provided by the data signal terminal Vdata is written to the preset node A. The driving transistor DT is turned on under the control of the voltage difference between the first node N1 and the second node N2, that is, the bias voltage. When the potential of the first node N1 becomes VDD+Vth, (Vth is the threshold voltage of the driving transistor DT), the bias voltage Vgs of the driving transistor DT is 0. In this case, the driving transistor DT is turned off, so that the threshold voltage Vth of the driving transistor DT is written to the first node N1.

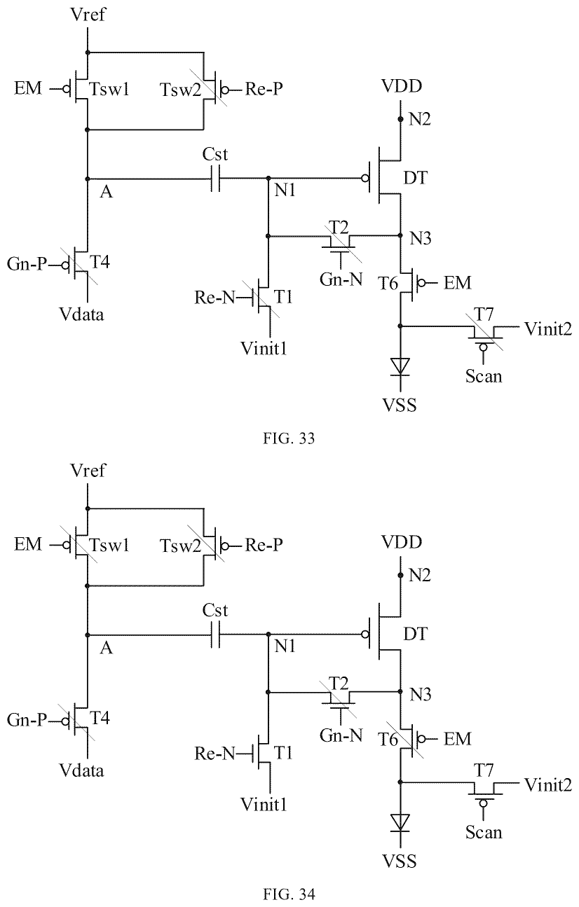

In the light-emitting stage t3 of the refresh frame, the second reset signal terminal Re-P outputs a high-level signal, the first reset signal terminal Re-N outputs a low-level signal, the first gate signal terminal Gn-N outputs a low-level signal, the second gate signal terminal Gn-P outputs a high-level signal, the scan signal terminal Scan outputs a high-level signal, and the enable signal terminal EM outputs a low-level signal. FIG. 33 is an equivalent circuit diagram of the pixel driving circuit of FIG. 29 in a light-emitting stage of a refresh frame. As shown in FIG. 33, the first switch transistor Tsw1 and the sixth transistor T6 are turned on, the reference voltage signal Vref is written to the preset node A, and the voltage change ΔVA of the preset node A is Vref-Vdata. In addition, the first node N1 is floating, and the storage capacitor Cst couples the voltage change ΔVA of the preset node A to the first node N1, so that the voltage of the first node N1 becomes Vn1=VDD+Vth+(Vref−Vdata), a loop is formed from the first power terminal VDD to the second power terminal VSS, and the light-emitting device OLED emits light under the driving current provided by the driving transistor DT.

$$According to the current formula : I = 1 / 2 {k ( {V}_{GS} - Vth )}^{2} \qquad ( 1 )$$

Substituting the above VGS into the equation (1), the driving current can be obtained as:

$$I = 1 / 2 {k ( Vref - Vdata )}^{2} \qquad ( 2 )$$

It can be seen that the driving current is only related to the reference voltage Vref and the data voltage Vdata, and is not related to the voltage (driving voltage) of the first voltage terminal Vdd, thereby achieving compensation of the threshold voltage and the driving voltage. Therefore, driving voltages at different positions of the driving circuit will not be affected by a voltage drop of the first power line itself, thereby achieving IR drop compensation on the first power line.

In the reset stage t1′ of the hold frame, the second reset signal terminal Re-P outputs a high-level signal, the first reset signal terminal Re-N outputs a high-level signal, the first gate signal terminal Gn-N outputs a low-level signal, the second gate signal terminal Gn-P outputs a high-level signal, the scan signal terminal Scan outputs a low-level signal, and the enable signal terminal EM outputs a high-level signal. FIG. 34 is an equivalent circuit diagram of a pixel driving circuit of FIG. 29 in a reset stage of a hold frame. As shown in FIG. 34, the first transistor T1 and the seventh transistor T7 are turned on, and other transistors are turned off. The preset node A is floating, and the first transistor T1 is turned on to write the first initialization signal to the first node N1. In this stage, the voltage change ΔVN1 of the first node N1 is Vinit1−[VDD+Vth+(Vref−Vdata)], and the storage capacitor Cst couples this voltage change to the preset node A, and accordingly, the voltage VA of the preset node A becomes Vref+Vinit1−[VDD+Vth+(Vref−Vdata)]. In this case, the voltage difference between the first node N1 and the second node N2 is Vinit1−VDD, that is, the bias voltage Vgs of the driving transistor DT is Vinit1−VDD. It can be seen that the bias voltage of the driving transistor DT is the same as the bias voltage of the driving transistor DT in the reset stage of the refresh frame, so that the driving transistor DT has the same bias voltage in the hold frame and the refresh frame, thereby eliminating or improving the difference in the display brightness between the refresh frame and the hold frame caused by the different bias voltages of the driving transistor DT.

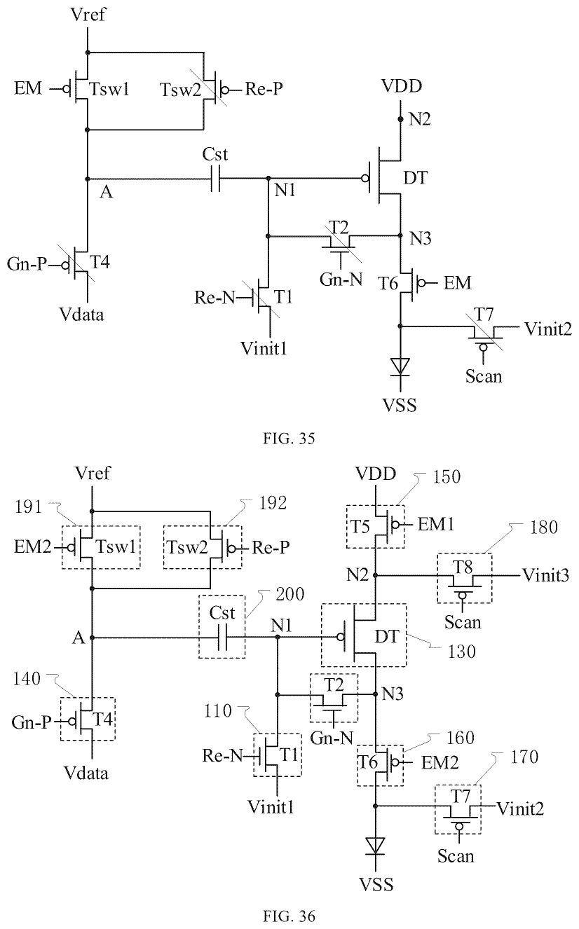

In the light-emitting stage t3′ of the hold frame, the second reset signal terminal Re-P outputs a high-level signal, the first reset signal terminal Re-N outputs a low-level signal, the first gate signal terminal Gn-N outputs a low-level signal, the second gate signal terminal Gn-P outputs a high-level signal, the scan signal terminal Scan outputs a high-level signal, and the enable signal terminal EM outputs a low-level signal. FIG. 35 is an equivalent circuit diagram of the pixel driving circuit of FIG. 29 in a light-emitting stage of a hold frame. As shown in FIG. 35, the first switch transistor Tsw1 and the sixth transistor T6 are turned on, the reference voltage signal Vref is written to the preset node A, the voltage of the preset node A changes back to Vref, and the voltage change of the preset node A is ΔVA=Vref−[Vref+Vinit1−[VDD+Vth+(Vref−Vdata)]]=[VDD+Vth+(Vref−Vdata)]−Vinit1. In addition, the first node N1 is floating, and the storage capacitor Cst couples the voltage change ΔVA of the preset node A to the first node N1, so that the voltage of the first node N1 becomes VN1=VDD+Vth+(Vref-Vdata), which is the same as the voltage in the light-emitting stage of the refresh frame, and the light-emitting device OLED emits light under the action of the driving current provided by the driving transistor DT.

It can be seen that in the pixel driving circuit provided by this embodiment, by adding a gate reset process of the driving transistor DT in the hold frame, the degree of bias voltage Vgs to which the driving transistor DT is subjected is the same as the degree of bias to which the driving transistor DT is subjected in the reset stage t1 of the refreshed frame, and the bias voltages are both Vinit1−VDD, which is not related to the voltage of the data signal Vdata, and can effectively solve the problem of incompatibility between different brightness or high and low grayscales. In addition, after the first node N1 obtains the threshold voltage of the driving transistor DT in the data writing stage, the driving transistor DT is almost turned off, and the influence of this process on the state of the driving transistor DT is reduced. Therefore, the pixel driving circuit and the driving method thereof in this embodiment can ensure that operating states in the refresh frame and the hold frame are consistent, thereby eliminating the brightness difference between the hold frame and the refresh frame, and improving the flickering feeling of low-frequency driving.

FIG. 36 is a schematic structural diagram of a pixel driving circuit according to another embodiment of the present disclosure. As shown in FIG. 36, in an embodiment, the constant voltage terminal VM is the reference voltage terminal Vref, that is, the preset node A is connected to the reference voltage terminal Vref through the first switch module 190. The switch signal terminal SW may include a first switch signal terminal and a second switch signal terminal, the reset signal terminal Re may include a first reset signal terminal Re-N and a second reset signal terminal Re-P, the enable signal terminal may include a first enable signal terminal EM1 and a second enable signal terminal EM2, the first switch signal terminal may reuse the second reset signal terminal Re-P, and the second switch signal terminal may reuse the second enable signal terminal EM2. A cathode of the light-emitting device OLED may be connected to the second power terminal VSS. The pixel driving circuit may further include a second reset module 180 and a first light-emitting control module 150. The second reset module 180 is connected between the second node N2 and the third initialization signal terminal Vinit3 and connected to the scan signal terminal Scan. The second reset module 180 may be configured to transmit the signal of the third initialization signal terminal Vinit3 to the second node N2 in response to the signal of the scan signal terminal Scan to reset the second node N2. The first light-emitting control module 150 is connected between the second node N2 and the first power terminal VDD and connected to the first enable signal terminal EM1. The first light-emitting control module 150 may be configured to transmit the voltage signal of the first power terminal VDD to the second node N2 in response to the signal of the first enable signal terminal EM1. In addition, the pixel driving circuit may further include the entire structure of the pixel driving circuit shown in FIG. 29, which will not be described in detail here.

As shown in FIG. 36, in an embodiment, the pixel driving circuit can also be implemented by a transistor. For example, the second reset module 180 may include an eighth transistor T8, a first electrode of the eighth transistor T8 is connected to the second node N2, a second electrode of the eighth transistor T8 is connected to the third initialization signal terminal Vinit3, and a gate of the eighth transistor T8 is connected to the scan signal terminal Scan, and the eighth transistor T8 may be configured to transmit the signal of the third initialization signal terminal Vinit3 to the second node N2 in response to the signal of the scan signal terminal Scan to reset the second node N2. The first light control module 150 may include a fifth transistor T5, a first electrode of the fifth transistor T5 is connected to the first power terminal VDD, a second electrode of the fifth transistor T5 is connected to the second node N2, and a gate of the fifth transistor T5 is connected to the first enable signal terminal EM1, and the fifth transistor T5 may be configured to transmit the voltage signal of the first power terminal VDD to the second node N2 in response to the signal of the first enable signal terminal EM1. In this embodiment, the fifth transistor T5 and the eighth transistor T8 can both be P-type transistors. For specific circuits of other modules in this embodiment, reference may be made FIG. 29, which will not be described in detail here.

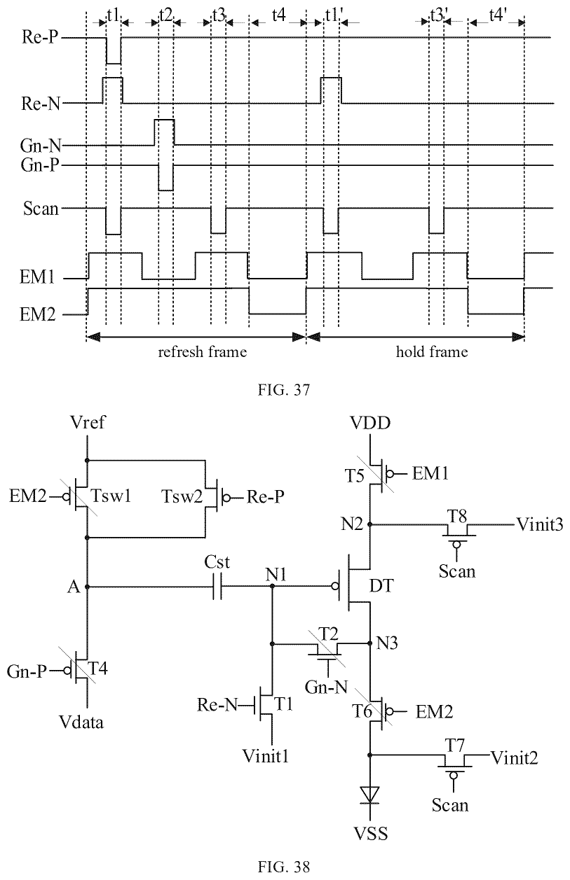

FIG. 37 is a timing diagram of respective nodes in FIG. 36, in which Re-P represents the timing of the second reset signal terminal Re-P, Re-N represents the timing of the first reset signal terminal, Gn-N represents the timing of the first gate signal terminal, Gn-P represents the timing of the second gate signal terminal, Scan represents the timing of the scan signal terminal, EM1 represents the timing of the first enable signal terminal, and EM2 represents the timing of the second enable signal terminal. The driving process of the pixel driving may include a refresh frame and a hold frame, the refresh frame may include a reset stage, a data writing stage, and a light-emitting stage, and the hold frame may include a reset stage and a light-emitting stage.

As shown in FIG. 37, in the reset stage t1 of the refresh frame, the second reset signal terminal Re-P outputs a low-level signal, the first reset signal terminal Re-N outputs a high-level signal, the first gate signal terminal Gn-N outputs a low-level signal, the second gate signal terminal Gn-P outputs a high-level signal, the scan signal terminal Scan outputs a low-level signal, and the first enable signal terminal EM1 and the second enable signal terminal EM2 both output high-level signals. FIG. 38 is an equivalent circuit diagram of the pixel driving circuit of FIG. 36 in a reset stage of a refresh frame. As shown in FIG. 38, the first transistor T1, the seventh transistor T7, the eighth transistor T8 and the second switch transistor Tsw2 are turned on, and other transistors are turned off. In this process, the voltage of the preset node A is Vref. The first initialization signal is transmitted to the first node N1 to reset the first node N1, the second initialization signal is transmitted to the anode of the light-emitting device OLED to reset the anode of the light-emitting device OLED, and the third initialization signal is transmitted to the second node N2 to reset the second node N2. Accordingly, the voltage of the first node N1 becomes Vinit1, and the voltage difference between the first node N1 and the second node N2 is Vinit1−Vinit3, which is the bias voltage Vgs of the driving transistor DT.

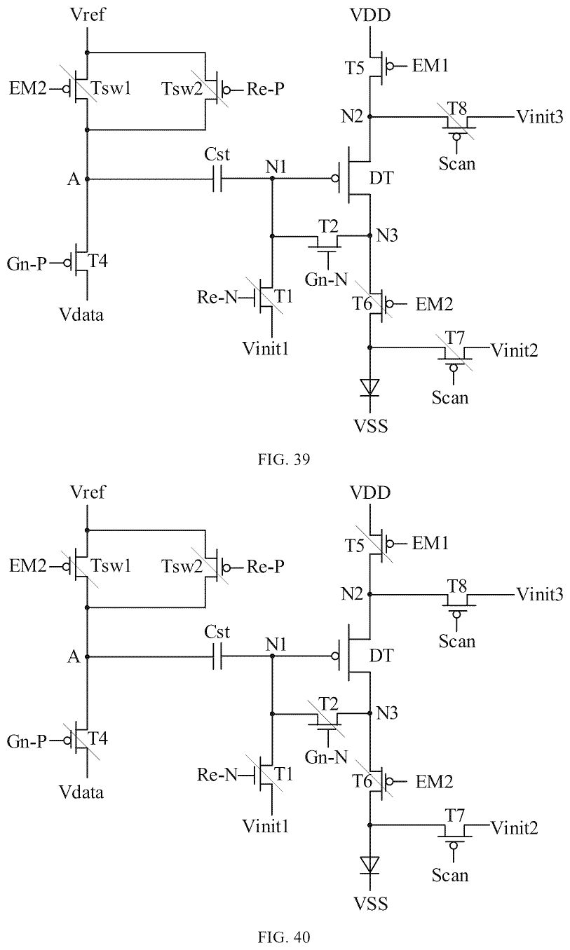

In the data writing stage t2 of the refresh frame, the second reset signal terminal Re-P outputs a high-level signal, the first reset signal terminal Re-N outputs a low-level signal, the first gate signal terminal Gn-N outputs a high-level signal, the second gate signal terminal Gn-P outputs a low-level signal, the scan signal terminal Scan outputs a high-level signal, the first enable signal terminal EM1 outputs a low-level signal, and the second enable signal terminal EM2 outputs a high-level signal. FIG. 39 is an equivalent circuit diagram of the pixel driving circuit of FIG. 36 in a data writing stage of a refresh frame. As shown in FIG. 39, the second transistor T2, the fourth transistor T4 and the fifth transistor T5 are turned on. In this case, the data signal provided by the data signal terminal Vdata is written to the preset node A. The voltage of the second node N2 becomes VDD, and the driving transistor DT is turned on under the control of the voltage difference between the first node N1 and the second node N2, i.e., the bias voltage. When the potential of the first node N1 becomes VDD+Vth (Vth is the threshold voltage of the driving transistor DT), the bias voltage Vgs of the driving transistor DT is 0. In this case, the driving transistor DT is turned off, so that the threshold voltage Vth of the driving transistor DT is written to the first node N1.

In the pre-light-emitting bias stage t3 of the refresh frame, the second reset signal terminal Re-P outputs a high-level signal, the first reset signal terminal Re-N outputs a low-level signal, the first gate signal terminal Gn-N outputs a low-level signal, the second gate signal terminal Gn-P outputs a high-level signal, the scan signal terminal Scan outputs a low-level signal, and the first enable signal terminal EM1 and the second enable signal terminal EM2 both output high-level signals. FIG. 40 is an equivalent circuit diagram of the pixel driving circuit of FIG. 36 in a pre-light-emitting bias stage of a refresh frame. As shown in FIG. 40, the seventh transistor T7 and the eighth transistor T8 are turned on, and the second node N2 is reset once by the third initialization signal. It should be understood that the pre-light-emitting bias stage in this embodiment can also have the effect of improving the hysteresis of the driving transistor DT and eliminating the afterimage as described in the above embodiments, which will not be repeated here.

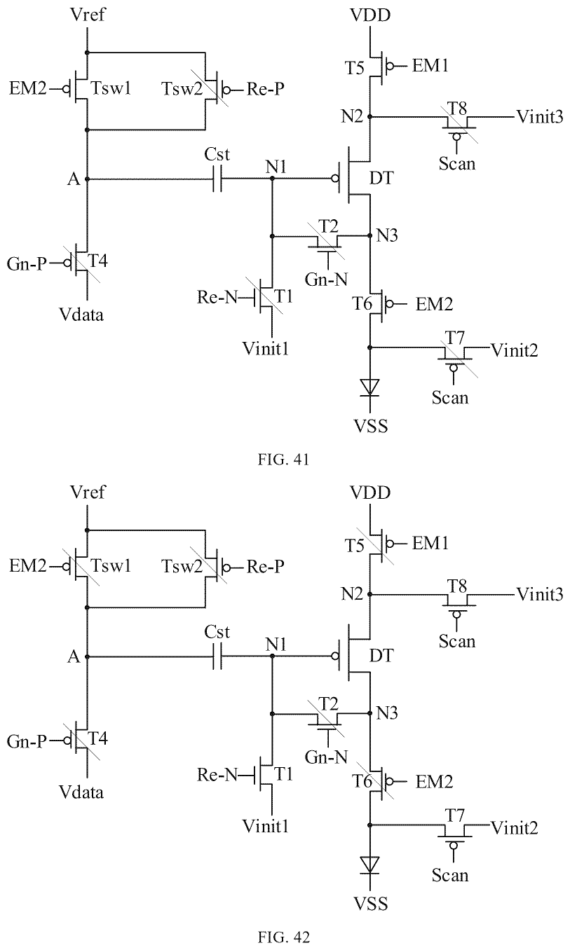

In the light-emitting stage t4 of the refresh frame, the second reset signal terminal Re-P outputs a high-level signal, the first reset signal terminal Re-N outputs a low-level signal, the first gate signal terminal Gn-N outputs a low-level signal, the second gate signal terminal Gn-P outputs a high-level signal, the scan signal terminal Scan outputs a high-level signal, and the first enable signal terminal EM1 and the second enable signal terminal EM2 both output low-level signals. FIG. 41 is an equivalent circuit diagram of the pixel driving circuit of FIG. 36 in a light-emitting stage of a refresh frame. As shown in FIG. 41, the first switch transistor Tsw1, the fifth transistor T5 and the sixth transistor T6 are turned on, the reference voltage signal Vref is written to the preset node A, and the voltage change ΔVA of the preset node A is Vref-Vdata. In addition, the first node N1 is floating, and the storage capacitor Cst couples the voltage change ΔVA of the preset node A to the first node N1, so that the voltage of the first node N1 becomes Vn1=VDD+Vth+(Vref−Vdata), a loop is formed from the first power terminal VDD to the second power terminal VSS, and the light-emitting device OLED emits light under the driving current provided by the driving transistor DT. This process is the same as the light-emitting process of the circuit shown in FIG. 29, which will not be described in detail here.

In the reset stage t1′ of the hold frame, the second reset signal terminal Re-P outputs a high-level signal, the first reset signal terminal Re-N outputs a high-level signal, the first gate signal terminal Gn-N outputs a low-level signal, the second gate signal terminal Gn-P outputs a high-level signal, the scan signal terminal Scan outputs a low-level signal, and the first enable signal terminal EM1 and the second enable signal terminal EM2 both output high-level signals. FIG. 42 is an equivalent circuit diagram of the pixel driving circuit of FIG. 36 in a reset stage of a hold frame. As shown in FIG. 42, the first transistor T1, the seventh transistor T7 and the eighth transistor T8 are turned on, and other transistors are turned off. The preset node A is floating, and the first transistor T1 is turned on to write the first initialization signal to the first node N1, the voltage difference between the first node N1 and the second node N2 is Vinit1−Vinit3, which is the bias voltage Vgs of the driving transistor DT. It can be seen that the bias voltage of the driving transistor DT is the same as the bias voltage of the driving transistor DT in the reset stage of the refresh frame, so that the driving transistor DT has the same bias voltage in the hold frame and the refresh frame, thereby eliminating or improving the difference in the display brightness between the refresh frame and the hold frame caused by the different bias voltages of the driving transistor DT. In this stage, the voltage change ΔVN1 of the first node N1 is Vinit1−[VDD+Vth+(Vref−Vdata)], and the storage capacitor Cst couples this voltage change to the preset node A, and accordingly, the voltage of the preset node A becomes

$$VA = Vref + Vinit 1 - [ VDD + Vth + ( Vref - Vdata ) ] = Vinit1 - VDD - Vth + Vdata .$$

Then, as shown in FIG. 37, the second reset signal terminal Re-P outputs a high-level signal, the first reset signal terminal Re-N outputs a low-level signal, the first gate signal terminal Gn-N outputs a low-level signal, the second gate signal terminal Gn-P outputs a high-level signal, the scan signal terminal Scan outputs a high-level signal, the first enable signal terminal EM1 outputs a low-level signal, and the second enable signal terminal EM2 outputs a high-level signal. Thus, the voltage of the second node N2 becomes VDD, and in this case, the voltage difference between the first node N1 and the second node N2 is Vinit1−VDD, that is, the bias voltage Vgs of the driving transistor DT is Vinit1−VDD.

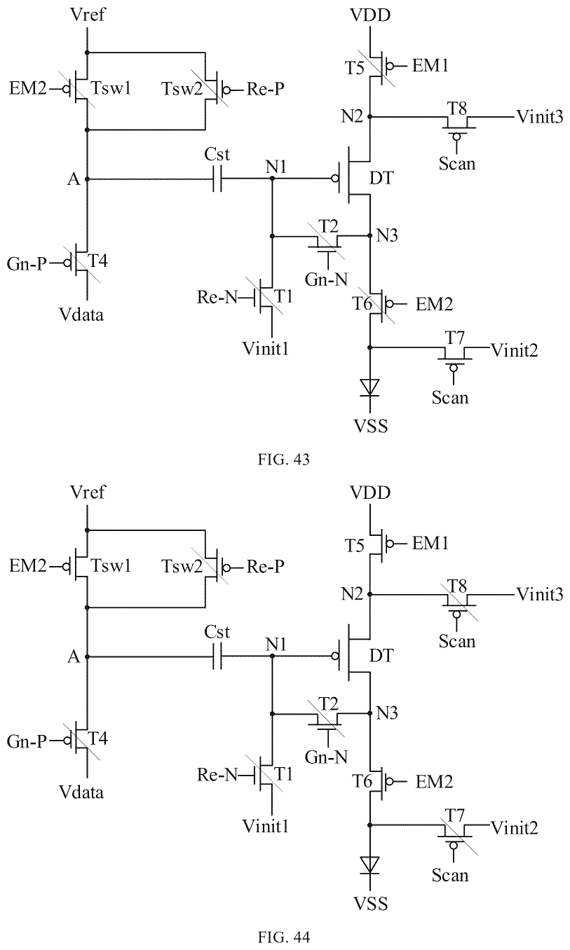

In the pre-light-emitting bias stage t3′ of the hold frame, the second reset signal terminal Re-P outputs a high-level signal, the first reset signal terminal Re-N outputs a low-level signal, the first gate signal terminal Gn-N outputs a low-level signal, the second gate signal terminal Gn-P outputs a high-level signal, the scan signal terminal Scan outputs a low-level signal, and the first enable signal terminal EM1 and the second enable signal terminal EM2 both output high-level signals. FIG. 43 is an equivalent circuit diagram of the pixel driving circuit of FIG. 36 in a pre-light-emitting bias stage of a hold frame. As shown in FIG. 43, the seventh transistor T7 and the eighth transistor T8 are turned on, and the second node N2 is reset once by the third initialization signal.

In the light-emitting stage t4′ of the hold frame, the second reset signal terminal Re-P outputs a high-level signal, the first reset signal terminal Re-N outputs a low-level signal, the first gate signal terminal Gn-N outputs a low-level signal, the second gate signal terminal Gn-P outputs a high-level signal, the scan signal terminal Scan outputs a high-level signal, and the first enable signal terminal EM1 and the second enable signal terminal EM2 both output low-level signals. FIG. 44 is an equivalent circuit diagram of the pixel driving circuit of FIG. 36 in a data writing stage of a hold frame. As shown in FIG. 44, the first switch transistor Tsw1, the fifth transistor T5 and the sixth transistor T6 are turned on, the reference voltage signal Vref is written to the preset node A, the voltage of the preset node A changes back to Vref, and the voltage change of the preset node A is ΔVA=Vref−[Vref+Vinit1−[VDD+Vth+(Vref−Vdata)]]=[VDD+Vth+(Vref−Vdata)]−Vinit1. In addition, the first node N1 is floating, and the storage capacitor Cst couples the voltage change ΔVA of the preset node A to the first node N1, so that the voltage of the first node N1 becomes VN1=VDD+Vth+(Vref−Vdata), which is the same as the voltage in the light-emitting stage of the refresh frame, and the light-emitting device OLED emits light under the action of the driving current provided by the driving transistor DT.

The present disclosure further provides a driving method for a pixel driving circuit, which is configured to drive the pixel driving circuit described in any embodiment of the present disclosure, and the driving method includes a refresh frame stage and a hold frame stage, and the driving method includes: in a reset stage of a light-emitting frame, respectively controlling the switch signal terminal and the reset signal terminal to output on-levels, wherein the first switch module is turned on in response to the signal of the switch signal terminal to stabilize the preset node using the constant voltage terminal, the first reset module is turned on in response to the signal of the reset signal terminal to write the signal of the first initialization signal terminal to the first node; in a reset stage of a hold frame, respectively controlling the switch signal terminal to output a non-on level and the reset signal terminal to output an on-level, wherein the first switch module is turned off in response to the signal of the switch signal terminal to make the preset node float, the first reset module is turned on in response to the signal of the reset signal terminal to write the signal of the first initialization signal terminal to the first node, and the voltage change of the first node is coupled to the preset node by the coupling module; after the reset stage of the hold frame, respectively controlling the reset signal terminal to output a non-on level and the switch signal terminal to output an on-level, wherein the first reset module is turned off in response to the signal of the reset signal terminal to make the first node float, the first switch module is turned on in response to the signal of the switch signal terminal to stabilize the preset node using the constant voltage terminal, and the voltage change of the preset node is coupled to the first node by the coupling module.

The present disclosure further provides a display device, which may include the display panel described in any of the above embodiments.

Other embodiments of the present disclosure will be apparent to those skilled in the art from consideration of the specification and practice of the present disclosure disclosed herein. The present disclosure is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

1. A pixel driving circuit, comprising:
a first reset module, connected to a first node, a first initialization signal terminal and a reset signal terminal, wherein the first reset module is configured to write a signal of the first initialization signal terminal into the first node in response to a signal of the reset signal terminal;
a driving module, connected to the first node, a second node and a third node, wherein the driving module is configured to provide a driving current to the third node based on voltages of the first node and the second node;
a coupling module, connected to the first node and a preset node, wherein the coupling module is configured to couple a voltage change of the first node to the preset node and couple a voltage change of the preset node to the first node; and
a first switch module, connected to a constant voltage terminal, the preset node and a switch signal terminal, wherein the first switch module is configured to turn on in response to a signal of the switch signal terminal to stabilize the preset node using the constant voltage terminal or to turn off in response to the signal of the switch signal terminal to control the preset node to float.

2. The pixel driving circuit according to claim 1, wherein the constant voltage terminal is a first power terminal, and the pixel driving circuit further comprises:
a first transmission module, connected to the first node, the third node and a gate signal terminal, wherein the first transmission module is configured to turn on or turn off a connection between the first node and the third node in response to a signal of the gate signal terminal.

3. The pixel driving circuit according to claim 2, wherein the reset signal terminal comprises a first reset signal terminal, and the first reset module is connected to the first reset signal terminal;
the gate signal terminal comprises a first gate signal terminal, and the first transmission module is connected to the first gate signal terminal; and
on-levels of the first reset module and the first transmission module are both opposite in polarity to an on-level of the driving module.

4. The pixel driving circuit according to claim 3, wherein:
the first reset module comprises:
a first transistor, wherein a first electrode of the first transistor is connected to the first initialization signal terminal, a second electrode of the first transistor is connected to the first node, and a gate of the first transistor is connected to the first reset signal terminal, and the first transistor is configured to transmit the signal of the first initialization signal terminal to the first node in response to the signal of the first reset signal terminal;
the first transmission module comprises:
a second transistor, wherein a first electrode of the second transistor is connected to the first node, a second electrode of the second transistor is connected to the third node, and a gate of the second transistor is connected to the first gate signal terminal, and the second transistor is configured to turn on the connection between the third node and the first node in response to the signal of the first gate signal terminal;
the driving module comprises:
a driving transistor, wherein a first electrode of the driving transistor is connected to the second node, a second electrode of the driving transistor is connected to the third node, and a gate of the driving transistor is connected to the first node, and the driving transistor is configured to provide the driving current to the third node based on the voltages of the first node and the second node; and
the first transistor and the second transistor are both N-type transistors, and the driving transistor is a P-type transistor.

5. The pixel driving circuit according to claim 2, wherein:
the reset signal terminal comprises a second reset signal terminal, and the first reset module is connected to the second reset signal terminal;
the gate signal terminal comprises a first gate signal terminal and a second gate signal terminal, and the first transmission module is connected to the second gate signal terminal;
the pixel driving circuit further comprises:
a second switch module, serially connected between the first node and the first reset module and connected to the first gate signal terminal, wherein the second switch module is at least configured to connect the first reset signal module to the first node in response to a signal of the first gate signal terminal to transmit the signal of the first initialization signal terminal to the first node; and
on-levels of the first reset module and the first transmission module are both the same in polarity as an on-level of the driving module, and an on-level of the second switch module is opposite in polarity to the on-level of the driving module.

6. The pixel driving circuit according to claim 5, wherein:
the first reset module comprises:
a first transistor, wherein a first electrode of the first transistor is connected to the first initialization signal terminal, a second electrode of the first transistor is connected to a fourth node, and a gate of the first transistor is connected to the second reset signal terminal, and the first transistor is configured to transmit the signal of the first initialization signal terminal to the fourth node in response to the signal of the second reset signal terminal;
the first transmission module comprises:
a second transistor, wherein a first electrode of the second transistor is connected to the fourth node, a second electrode of the second transistor is connected to the third node, and a gate of the second transistor is connected to the second gate signal terminal, and the second transistor is configured to turn on a connection between the third node and the fourth node in response to the signal of the second gate signal terminal;
the second switch module comprises:
a tenth transistor, wherein a first electrode of the tenth transistor is connected to the first node, a second electrode of the tenth transistor is connected to the fourth node, and a gate of the tenth transistor is connected to the first gate signal terminal, and the tenth transistor is configured to turn on or turn off a connection between the first node and the fourth node in response to the signal of the first gate signal terminal;
the driving module comprises:
a driving transistor, wherein a first electrode of the driving transistor is connected to the second node, a second electrode of the driving transistor is connected to the third node, and a gate of the driving transistor is connected to the first node, and the driving transistor is configured to provide the driving current to the third node based on the voltages of the first node and the second node; and
the first transistor, the second transistor and the driving transistor are all P-type transistors, and the tenth transistor is an N-type transistor.

7. The pixel driving circuit according to claim 1, wherein the constant voltage terminal is a first power terminal, and the pixel driving circuit further comprises:
a first transmission module, serially connected between the first node and the first reset module and connected to a first gate signal terminal, wherein the first transmission module and the first reset module are connected to the third node, and the first transmission module is at least configured to turn on a connection between the first reset module and the first node in response to a signal of the first gate signal terminal to transmit the signal of the first initialization signal terminal to the first node;
the reset signal terminal comprises a second reset signal terminal, and the first reset module is connected to the second reset signal terminal; and
an on-level of the first reset module is the same in polarity as an on-level of the driving module, and an on-level of the first transmission module is opposite in polarity to the on-level of the driving module.

8. The pixel driving circuit according to claim 7, wherein:
the first reset module comprises:
a first transistor, wherein a first electrode of the first transistor is connected to the first initialization signal terminal, a second electrode of the first transistor is connected to the third node, and a gate of the first transistor is connected to the second reset signal terminal, and the first transistor is configured to transmit the signal of the first initialization signal terminal to the third node in response to the signal of the second reset signal terminal;
the first transmission module comprises:
a second transistor, wherein a first electrode of the second transistor is connected to the first node, a second electrode of the second transistor is connected to the third node, and a gate of the second transistor is connected to the first gate signal terminal, and the second transistor is configured to turn on the connection between the third node and the first node in response to the signal of the first gate signal terminal;
the driving module comprises:
a driving transistor, wherein a first electrode of the driving transistor is connected to the second node, a second electrode of the driving transistor is connected to the third node, and a gate of the driving transistor is connected to the first node, and the driving transistor is configured to provide the driving current to the third node based on the voltages of the first node and the second node; and
the first transistor and the driving transistor are both P-type transistors, and the second transistor is an N-type transistor.

9. The pixel driving circuit according to claim 2, wherein the pixel driving circuit further comprises:
a second reset module, connected to the second node, a third initialization signal terminal and a scan signal terminal, wherein the second reset module is configured to write a signal of the third initialization signal terminal to the second node in response to a signal of the scan signal terminal;
a data writing module, connected to the second node, a data signal terminal and a second gate signal terminal, wherein the data writing module is configured to transmit a signal of the data signal terminal to the second node in response to a signal of the second gate signal terminal;
a first light-emitting control module, connected to the second node, the first power terminal and an enable signal terminal, wherein the first light-emitting control module is configured to transmit a voltage signal of the first power terminal to the second node in response to a signal of the enable signal terminal;
a second light-emitting control module, connected to the third node, an anode of a light-emitting device and the enable signal terminal, wherein the second light-emitting control module is configured to transmit a current signal of the third node to the anode of the light-emitting device in response to the signal of the enable signal terminal; and
a third reset module, connected to the anode of the light-emitting device, a second initialization signal terminal and the scan signal terminal, wherein the third reset module is configured to transmit a signal of the second initialization signal terminal to the anode of the light-emitting device in response to the signal of the scan signal terminal to reset the anode of the light-emitting device.

10. The pixel driving circuit according to claim 9, wherein:
the second reset module comprises:
an eighth transistor, wherein a first electrode of the eighth transistor is connected to the third initialization signal terminal, a second electrode of the eighth transistor is connected to the second node, and a gate of the eighth transistor is connected to the scan signal terminal, and the eighth transistor is configured to transmit the signal of the third initialization signal terminal to the second node in response to the signal of the scan signal terminal to reset the second node;
the data writing module comprises:
a fourth transistor, wherein a first electrode of the fourth transistor is connected to the data signal terminal, a second electrode of the fourth transistor is connected to the second node, and a gate of the fourth transistor is connected to the second gate signal terminal, and the fourth transistor is configured to transmit the signal of the data signal terminal to the second node in response to the signal of the second gate signal terminal;
the switch signal terminal comprises a first switch signal terminal;
the first light-emitting control module comprises:
a fifth transistor, wherein a first electrode of the fifth transistor is connected to the first power terminal, a second electrode of the fifth transistor is connected to the second node, and a gate of the fifth transistor is connected to the enable signal terminal, and the fifth transistor is configured to transmit the voltage signal of the first power terminal to the second node in response to the signal of the enable signal terminal;
the second light-emitting control module comprises:
a sixth transistor, wherein a first electrode of the sixth transistor is connected to the third node, a second electrode of the sixth transistor is connected to the anode of the light-emitting device, and a gate of the sixth transistor is connected to the enable signal terminal, and the sixth transistor is configured to transmit the current signal of the third node to the anode of the light-emitting device in response to the signal of the enable signal terminal;
the third reset module comprises:
a seventh transistor, wherein a first electrode of the seventh transistor is connected to the second initialization signal terminal, a second electrode of the seventh transistor is connected to the anode of the light-emitting device, and a gate of the seventh transistor is connected to the scan signal terminal, and the seventh transistor is configured to transmit the signal of the second initialization signal terminal to the anode of the light-emitting device in response to the signal of the scan signal terminal to reset the anode of the light-emitting device;
the first switch module comprises:
a first switch transistor, wherein a first electrode of the first switch transistor is connected to the preset node, a second electrode of the first switch transistor is connected to the first power terminal, and a gate of the first switch transistor is connected to the first switch signal terminal, and the first switch transistor is configured to turn on in response to the signal of the first switch signal terminal to stabilize the preset node using the voltage signal of the first power terminal or turn off in response to the signal of the first switch signal terminal to control the preset node to float;
the coupling module comprises:
a storage capacitor, wherein a first electrode of the storage capacitor is connected to the first node, and a second electrode of the storage capacitor is connected to the preset node; and
the first switch transistor and the fourth transistor to the eighth transistor are all P-type transistors.

11. The pixel driving circuit according to claim 1, wherein:
the constant voltage terminal is a first power terminal;
the pixel driving circuit further comprises a first transmission module and a data writing module;
a gate signal terminal comprises a first gate signal terminal and a second gate signal terminal;
the first transmission module is connected to the first node, the third node and the first gate signal terminal, and the first transmission module is configured to turn on or turn off a connection between the first node and the third node in response to a signal of the first gate signal terminal;
the data writing module is connected to the second node, a data signal terminal and the second gate signal terminal, and the data writing module is configured to transmit a signal of the data signal terminal to the second node in response to a signal of the second gate signal terminal;
an on-level of the first transmission module is opposite in polarity to an on-level of the data writing module; and
an on-level output by the second gate signal terminal is overlapped with an on-level output by the first gate signal terminal, and a duration covered by the on-level output by the second gate signal terminal is within a duration covered by the on-level output by the first gate signal terminal.

12. The pixel driving circuit according to claim 1, wherein when a non-on level output by the switch signal terminal is overlapped with an on-level output by the reset signal terminal, a duration covered by the on-level output by the reset signal terminal is within a duration covered by the non-on level output by the switch signal terminal.

13. The pixel driving circuit according to claim 1, wherein the constant voltage terminal is a reference voltage terminal, and the second node is further connected to a first power terminal.

14. The pixel driving circuit according to claim 13, wherein the pixel driving circuit further comprises:
a second reset module, connected between the second node and a third initialization signal terminal and connected to a scan signal terminal, wherein the second reset module is configured to transmit a signal of the third initialization signal terminal to the second node in response to a signal of the scan signal terminal to reset the second node; and
a first light-emitting control module, connected between the second node and the first power terminal and connected to a-first an enable signal terminal, wherein the first light-emitting control module is configured to transmit a voltage signal of the first power terminal to the second node in response to a signal of the enable signal terminal.

15. The pixel driving circuit according to claim 14, wherein the switch signal terminal comprises a second switch signal terminal, and the enable signal terminal is reused by the second switch signal terminal; and
the first switch module comprises:
a first sub-switch module, connected to the reference voltage terminal, the preset node and the enable signal terminal, wherein the first sub-switch module is at least configured to turn on in response to a signal of the enable signal terminal to stabilize the preset node using a voltage signal of the reference voltage terminal or turn off in response to the signal of the enable signal terminal to control the preset node to float.

16. The pixel driving circuit according to claim 15, wherein:
the reset signal terminal comprises a second reset signal terminal, the switch signal terminal further comprises a first switch signal terminal, and the second reset signal terminal is reused by the first switch signal terminal;
the enable signal terminal comprises a first enable signal terminal and a second enable signal terminal, the second enable signal terminal is reused by the second switch signal terminal, and the first sub-switch module is connected to the second enable signal terminal;
the first switch module further comprises:
a second sub-switch module, connected to the reference voltage terminal, the preset node and the second reset signal terminal, wherein the second sub-switch module is configured to transmit the voltage signal of the reference voltage terminal to the preset node in response to a signal of the second reset signal terminal; and
an on-level stage of the second reset signal terminal is not overlapped with an on-level stage of the second enable signal terminal.

17. The pixel driving circuit according to claim 16, wherein the pixel driving circuit further comprises:
a first transmission module, connected to the first node, the third node and a first gate signal terminal, wherein the first transmission module is configured to turn on or turn off a connection between the first node and the third node in response to a signal of the first gate signal terminal; and
on-levels of the first transmission module and the first reset module are opposite in polarity to an on-level of the driving module.

18. The pixel driving circuit according to claim 17, wherein:
the reset signal terminal further comprises a first reset signal terminal;
the first reset module comprises:
a first transistor, wherein a first electrode of the first transistor is connected to the first initialization signal terminal, a second electrode of the first transistor is connected to the first node, and a gate of the first transistor is connected to the first reset signal terminal, and the first transistor is configured to transmit the signal of the first initialization signal terminal to the first node in response to the signal of the first reset signal terminal;
the first transmission module comprises:
a second transistor, wherein a first electrode of the second transistor is connected to the first node, a second electrode of the second transistor is connected to the third node, and a gate of the second transistor is connected to the first gate signal terminal, and the second transistor is configured to turn on the connection between the third node and the first node in response to the signal of the first gate signal terminal;
the driving module comprises:
a driving transistor, wherein a first electrode of the driving transistor is connected to the second node, a second electrode of the driving transistor is connected to the third node, and a gate of the driving transistor is connected to the first node, and the driving transistor is configured to provide the driving current to the third node based on the voltages of the first node and the second node; and
the first transistor and the second transistor are both N-type transistors, and the driving transistor is a P-type transistor.

19. The pixel driving circuit according to claim 17, wherein the pixel driving circuit further comprises:
a data writing module, connected to the preset node, a data signal terminal and a second gate signal terminal, wherein the data writing module is configured to transmit a signal of the data signal terminal to the preset node in response to a signal of the second gate signal terminal;
a second light-emitting control module, connected to the third node, an anode of a light-emitting device and the second enable signal terminal, wherein the second light-emitting control module is configured to transmit a driving current of the third node to the anode of the light-emitting device in response to a signal of the second enable signal terminal; and
a third reset module, connected to the anode of the light-emitting device, a second initialization signal terminal and the scan signal terminal, wherein the third reset module is configured to transmit a signal of the second initialization signal terminal to the anode of the light-emitting device in response to the signal of the scan signal terminal to reset the anode of the light-emitting device.

20. The pixel driving circuit according to claim 19, wherein:
the data writing module comprises:
a fourth transistor, wherein a first electrode of the fourth transistor is connected to the data signal terminal, a second electrode of the fourth transistor is connected to the preset node, and a gate of the fourth transistor is connected to the second gate signal terminal, and the fourth transistor is configured to transmit the signal of the data signal terminal to the preset node in response to the signal of the second gate signal terminal;
the second light-emitting control module comprises:
a sixth transistor, wherein a first electrode of the sixth transistor is connected to the third node, a second electrode of the sixth transistor is connected to the anode of the light-emitting device, and a gate of the sixth transistor is connected to the second enable signal terminal, and the sixth transistor is configured to transmit the driving current of the third node to the anode of the light-emitting device in response to the signal of the second enable signal terminal;
the third reset module comprises:
a seventh transistor, wherein a first electrode of the seventh transistor is connected to the second initialization signal terminal, a second electrode of the seventh transistor is connected to the anode of the light-emitting device, and a gate of the seventh transistor is connected to the scan signal terminal, and the seventh transistor is configured to transmit the signal of the second initialization signal terminal to the anode of the light-emitting device in response to the signal of the scan signal terminal to reset the anode of the light-emitting device;
the first sub-switch module comprises:
a first switch transistor, wherein a first electrode of the first switch transistor is connected to the reference voltage terminal, a second electrode of the first switch transistor is connected to the preset node, and a gate of the first switch transistor is connected to the second enable signal terminal, and the first switch transistor is configured to turn on in response to the signal of the second enable signal terminal to stabilize the preset node using the voltage signal of the reference voltage terminal or turn off in response to the signal of the second enable signal terminal to control the preset node to float;
the second sub-switch module comprises:
a second switch transistor, wherein a first electrode of the second switch transistor is connected to the reference voltage terminal, a second electrode of the second switch transistor is connected to the preset node, and a gate of the second switch transistor is connected to the second reset signal terminal, and the second switch transistor is configured to transmit the voltage signal of the reference voltage terminal to the preset node in response to the signal of the second reset signal terminal;
the coupling module comprises:
a storage capacitor, wherein a first electrode of the storage capacitor is connected to the first node, and a second electrode of the storage capacitor is connected to the preset node;
the second reset module comprises:
an eighth transistor, wherein a first electrode of the eighth transistor is connected to the second node, a second electrode of the eighth transistor is connected to the third initialization signal terminal, and a gate of the eighth transistor is connected to the scan signal terminal, and the eighth transistor is configured to transmit the signal of the third initialization signal terminal to the second node in response to the signal of the scan signal terminal to reset the second node;
the first light-emitting control module comprises:
a fifth transistor, wherein a first electrode of the fifth transistor is connected to the first power terminal, a second electrode of the fifth transistor is connected to the second node, and a gate of the fifth transistor is connected to the first enable signal terminal, and the fifth transistor is configured to transmit the voltage signal of the first power terminal to the second node in response to the signal of the first enable signal terminal; and
the first switch transistor, the second switch transistor, and the fourth transistor to the eighth transistor are all P-type transistors.

21.-22. (canceled)
